(19) United States
(12) Patent Application Publication
(10) Pub. No.: US 2013/0253894 A1
(43) Pub. Date: Sep. 26, 2013

(54) Systems And Methods For Predicting Protein-Protein Interactions

(71) Applicant: THE TRUSTEES OF COLUMBIA UNIVERSITY IN THE CITY OF NEW YORK, New York, NY (US)

(72) Inventors: Barry Honig, New York, NY (US); Donald Petrey, New York, NY (US); Andrea Califano, New York, NY (US); Lei Deng, New York, NY (US); Qiangfeng Cliff Zhang, New York, NY (US)

(21) Appl. No.: 13/789,255

(22) Filed: Mar. 7, 2013

Related U.S. Application Data
(60) Provisional application No. 61/607,906, filed on Mar. 7, 2012.

(51) Int. Cl. G06F 19/12

(52) U.S. Cl. CPC G06F 19/12
USPC 703/11

(57) ABSTRACT

The present subject matter relates to systems and methods for predicting molecular interactions within biological networks based on structural and non-structural indicators. Such molecules include but are not limited to proteins, nucleic acids and small molecules. In some embodiments, the present subject matter is directed to methods for predicting protein-protein interactions comprising obtaining a pair of query proteins, using sequence alignment to identify structural representatives for each of the pair of query proteins, and using structural alignment to determine sets of close and remote structural neighbors for each of the structural representatives. The method can include analyzing the close and remote structural neighbors to identify a reported complex, and using the reported complex to define a template for creating a model for interaction of the pair of query proteins. In another embodiment, the method includes determining sets of non-structural and structural-based scores to measure properties of the modeled interaction and the query proteins.

### CROSS-REFERENCE TO RELATED APPLICATIONS

This application claims priority to U.S. Provisional Patent Application No. 61/607,906, filed on Mar. 7, 2012, which is incorporated by reference herein in its entirety.

### STATEMENT REGARDING FEDERALLY-SPONSORED RESEARCH

This invention is made with government support under GM030518 and CA121852 awarded by the National Institute of Health. The government has certain rights in the invention.

### BACKGROUND

Proteins play a significant role in regulating cellular events such as signal transduction, cell cycle, protein trafficking, targeted proteolysis, cytoskeletal organization and gene regulation/expression/translation. Many proteins carry out their function by physically interacting with other proteins or the same protein. Thus, genome-wide identification of interacting proteins can be important in the elucidation of cell regulatory mechanisms, in the development of pharmaceuticals, to determine protein function, and the like. Certain knowledge of protein-protein interaction networks can be derived from high-throughput experimental techniques, including techniques applied to genome-wide studies of protein-protein interactions for a number of model organisms.

Types of high-throughput experimental methods used to detect protein-protein interactions include the yeast two-hybrid screen, which can be limited to the detection of binary interactions, and the combination of large-scale purification with mass spectrometry to detect and characterize multi-protein complexes. Although these methods have revealed the dense network of interactions linking proteins in the cell, they can have a high false-positive rate and provide incomplete coverage of the protein-protein interactions. Furthermore, although mass spectrometry gives information concerning the proteins that form a particular complex, additional experiments can be needed to identify which proteins directly interact to mediate complex formation. A number of databases have been created to systematically collect and store information on experimentally determined protein-protein interactions. Hundreds of thousands of protein-protein interactions are stored in these databases and cover hundreds of different organisms. Although these databases are valuable resources, the accuracy and coverage of the databases can be limited.

Parallel to experimental studies, computational prediction methods can also be used to infer new protein-protein interactions. Such computational approaches can use information such as sequence and structural homology to predict the binding interface of a putative protein-protein interaction, in the absence or presence of a predicted three-dimensional structure. However, certain computational approaches identify potential functional relationships between proteins, which do not necessary imply direct physical protein-protein interactions.

### SUMMARY

The present disclosure provides systems and methods for predicting protein-protein interactions. The methods and systems for prediction of protein-protein interaction described herein can be used to predict large numbers of functional relationships of proteins, for example, on a genome-wide scale. Such systems and methods can be used in a variety of structural genomics initiatives. Additionally, locations of the interface on a protein surface for large numbers of protein-protein complexes can be predicted, and, thus, can be used to determine the presence of a physical interaction.

In an exemplary embodiment, the disclosed subject matter provides methods for predicting interactions between at least two query molecules, e.g., at least two protein molecules, using structural and non-structural based scores. Accordingly, in one embodiment, the method includes generating at least two structural representatives corresponding to at least two query molecules (e.g., proteins), identifying structural neighbors (e.g., close and remote structural neighbors) for each of the structural representatives, and modeling an interaction between the at least two query molecules to generate a modeled interaction; generating one or more structural-based scores to assess the modeled interaction; and combining the one or more structural-based scores into a combined structural-based score. In one embodiment, the structural-based scores are combined using a Bayesian network. One or more non-structural based scores is generated to assess the modeled interaction, and the likelihood that the modeled interaction represents a true interaction is determined from the combined structural-based score and the one or more non-structural based scores. In one embodiment, determining the likelihood that the modeled interaction represents a true interaction further includes using a Naïve Bayesian classifier to assign a likelihood ratio that each candidate protein-protein complex represents a true interaction.

In one embodiment, the one or more structural-based scores correspond to one or more scores determined by one or more of the following: determining a geometric similarity between the modeled interaction and the template complex; determining a number of interacting residue pairs in the template complex that are preserved in the modeled interaction; determining a fraction of interacting residue pairs in the template complex that are preserved in the modeled interaction; determining a number of interacting residue pairs in the template complex that align to a predicted interfacial residue in the modeled interaction; and determining a number of interfacial residues in the template complex that align with predicted interfacial residues in the modeled interaction.

In another embodiment, the one or more non-structural based scores are generated using one or more of: gene ontology functional similarity, MIPS functional similarity, phylogenetic profile similarity, and gene co-expression.

In one embodiment, the modeling includes superimposing the structural representatives on corresponding structural neighbors in a template to form a template complex.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: Predicting protein-protein interactions using PrePPI in one embodiment of the disclosed subject matter. Given a pair of query proteins that potentially interact (QA, QB), representative structures for the individual subunits (MA, MB) are taken from the Protein Data Bank (PDB), where available, or from homology model databases. For each subunit, both close and remote structural neighbors were identified. A “template” for the interaction exists whenever a PDB or PQS structure contains a pair of interacting chains (for example, NA₁-NB₃) that are structural neighbors of MA and MB, respectively. An interaction model is constructed by superposing the individual subunits, MA and MB, on their corresponding structural neighbors, NA₁ and NB₃. Five empirical-structure-based scores were assigned to each interaction model and then calculate a likelihood for each model to represent a true interaction by combining these scores using a Bayesian network trained on the HC and the N interaction reference sets. The structure-derived score (SM) is combined with non-structural evidence associated with the query proteins (for example, co-expression, functional similarity) using a naive Bayesian classifier.

FIG. 2: ROC curve and Venn diagram for PrePPI predictions and high-throughput experiments in yeast. A, ROC curve. B, Venn diagram. The CCSB-PRS positive reference interaction set is defined in reference [1] and described in the Methods of Example 1. High-throughput experiments are labeled with the first author of the relevant dataset. The number of interactions in each set is given after the set label in the Venn diagram.

FIG. 3: Models for the PPI formed between PRKD1 and PRKCE, and EEF1D and VHL using homology models and remote structural relationships. A, Model for PRKD1 and PRKCE. B, Model for EEF1D and VHL. The same template complex of ubiquitin-conjugating enzyme E2D 3 (UBE2D3) and ubiquitin (PDB accession: 2FUH; A and B chain, shown in blue and red respectively) was used in both cases. The structures of the PH domain of PRKD1 and the GNE domain of EEF1D (shown in green and purple) are homology models from ModBase; the structure of a C1 domain of PRKCE (yellow) is a homology model from SkyBase; the structure of VHL (cyan) is from PDB (accession 1LM8; V chain). In each case, the relevant homology models are structurally superimposed on one of the two templates in the UBE2D3-ubiquitin complex.

FIG. 4: Interaction Model Evaluation. The top of the figure shows a template complex (TA,TB) and an interaction model (MA,MB). Individual residues in the different chains of the template and model are shown as dots, colored to indicate whether they are interfacial (gray) or non-interfacial (white). Schematic representations of the amino acid sequences below their corresponding chain in the template and model are shown. Residues were determined as interfacial using the following criteria. For the template, interfacial residues were determined directly from the associated experimentally determined structure in the PDB using a 6.05 angstrom distance cutoff between heavy atoms². Interacting residue pairs (ta5/tb7, ta6/tb6, etc., black lines) were identified in the template using the same cutoff. For the model, interfacial residues in the individual query proteins were predicted using a combination of three programs: PredUs³, PINUP⁴ and cons-PPISP⁵. Note that these programs use only the structures and sequences of the individual subunits in the model (i.e., MA by itself and MB by itself) and hence are independent of the modeled complex. In this example, MA has 3 predicted interfacial residues (ma2, ma5, etc.) and MB has 4 (mb2, mb3, etc.). In practice, interacting residue pairs and predicted interfacial residues can be pre-calculated and stored for each template complex and query protein in order to allow efficient evaluation the of the billions of models that were generated. Each interaction model is associated with two structure-based sequence alignments (i.e., MA aligned to TA and MB aligned to TB). Evaluation of the 3-dimensional model was not done directly but used a set of five criteria (designated SIM, SIZ, COV, OS, OL), calculated from the alignments.

FIG. 5: Bayesian network for structural modeling. A Bayesian network was used to combine the five structure-based scores, i.e., SIM, COV, SIZ, OL, and OS (see FIG. 4), into a single term to evaluate an interaction model. A fully connected Bayesian network B4 was used for COV, SIZ, OL, and OS and combined with the SIM score using the naïve Bayesian approach (NB). For each score, discrete bins were defined as shown conceptually in the figure (bin sizes were adjusted manually to ensure adequate coverage of each bin).

FIG. 6: Number of predicted interactions vs. likelihood ratio (LR) using structural modeling and non-structure based clues. Different sources of information were examined (i.e. structural modeling (SM), GO, protein essentiality (ES), MIPS, co-expression (CE), or phylogenetic profile (PP)) for their ability to predict PPIs. Any three lines of the same shade and marker in the graph are associated with a particular clue and show numbers of predicted interactions with an LR above the cutoff, based on that clue. The total number of interactions predicted at a given cutoff is shown as a short-dashed line (P). The other two lines for a given clue correspond to whether the predictions are in the HC interaction set (solid line, TP), or in the union of the LC and HC interactions sets (long-dashed line, TP_ALL).

FIG. 7: ROC (receiver operating characteristic) curves for yeast and human PPIs predicted based on different sources of information in different interaction spaces. Results for yeast interaction were from 10-fold cross validation (A-D); for human interactions they were derived using the Bayesian network trained on yeast although virtually identical results were obtained with a cross validation on human data (E). In A and E, each ROC curve was restricted in the plot to only those interactions for which the associated single clue or combination of clues was available. Yeast ROC curves are shown using a single subset of protein pairs: (B) for the whole interaction space of 21 million protein pairs, (C) for the subset where information for all types of clues is available (116 thousand yeast protein pairs), (D) for the subset where structural information is available (2.4 million yeast interactions). The clues examined include structural modeling (SM), GO similarity, protein essentiality (ES) relationship, MIPS similarity, co-expression (CE), phylogenetic profile (PP) similarity, or their combinations (NS for the integration of all non-structure clues, i.e., GO, ES, MIPS, CE, and PP, and PrePPI for all structural and non-structure clues).

FIG. 8: Distributions of GO biological process (BP) similarity term for yeast protein pairs. BP similarity for two proteins was defined as the integer representing the level of their most recent common ancestor (MRCA) in the GO hierarchy, taking the maximum if multiple MRCAs are available. GO annotation for individual yeast proteins were extracted from UniProt and the similarity was calculated for different sets of pairs. The purple line shows the random distribution of similarities, i.e., for all protein pairs in yeast for which GO annotations could be found. The green line shows the distribution for protein pairs in the HC set of true interactions. The bars show the distribution of similarities for pairs of interactions predicted by structural modeling (SM) at an LR cutoff of 600 that are also in different reference sets that were used: the HC (green), LC (blue), and N (orange) sets. Only about 13% of random yeast interactions involve proteins that share an MRCA at least level 6 (the purple line). On the other hand, most true PPIs in the HC set (8,126 of 10,933, or 74%) share an MRCA level at least 6 (the green line). The MRCA levels for the SM predictions show similar shifts in the distribution. Specifically, at the LR cutoff 600, 434 of the predicted PPIs are in the HC data set, 363 in the LC data set and 2,640 in the N set. Of the 132 hetero-dimeric pairs in the LC set with GO annotation, 94 contain proteins that share GO biological term at, or more specific than, the 6th level of the GO hierarchy (blue bars), providing supporting evidence that these interactions are real (in addition to their presence in the LC set). Similarly, 960 of the 1,946 hetero-dimeric predictions in the N set contain proteins that share GO terms at level 6 (orange bars), indicating that there is at least a functional relationship which can involve protein-protein interactions.

FIG. 9: Comparison of the contribution of clues derived from structural modeling (SM) and non-structural information (NS). Venn diagrams are shown for the number of high confidence (LR>600) predictions made using SM and NS. Note that NS offers better coverage than SM for yeast but the reverse is true for human. In both cases, combining SM and NS into a PrePPI score offers an increase in the total number of predictions and in the coverage of the HC data set.

FIG. 10: Negative interaction reference set constructed using proteins in different cellular compartments. A number of proteins were randomly chosen based on their GO annotations and paired those from different cellular compartments to form the negative reference sets (shown as lines). There were several proteins annotated as belonging to two of these cellular compartments which were excluded. A very small number of interactions were also contained in the positive reference sets (e.g., HC, CCSB-PRS, and CCSB-BGS) which were removed from the new negative reference sets (i.e., the final sizes of the negative reference sets are very close to but not exactly the same number as shown in the figure).

FIG. 11: ROC carves of PrePPI predictions and high-throughput (HT) experiments on different interaction reference datasets. (A) A ROC curve of PrePPI predictions and HT experiments using the CCSB-PRS reference set (A), showing comparisons using additional positive reference sets: (B) CCSB-BGS, and (C) the yeast and (D) human HC sets defined in the main text. Results from PrePPI are displayed as green curves, and the predictions at LR cutoff 600 are highlighted with green “X”. HT experiments are shown as yellow diamonds with the datasets labeled with the name of the first author of the corresponding publications (see Table 4, below). The unions of HT experiments are marked with yellow “X”. The results consistently show that PrePPI predictions are comparable to most HT experimental studies.

FIG. 12: Venn diagrams of PrePPI predictions at different LR cutoffs, union of HT experiments, for different reference interaction datasets for yeast and human. (B) a Venn diagram of PrePPI predictions at an LR cutoff of 600, unions of HT experiments, and the CCSB-PRS reference set (A), showing results of PrePPI predictions for additional positive reference sets defined in the figure along with the number of interactions they contain (A-F for yeast and G-H for human interactions). The number after the label of a set shows the number of interaction in the set. The LR cutoff 600 was used as previously described⁶ and is based on the assumption that protein pairs with LR>600 have a better than 50% chance to be a true interaction. PrePPI predictions were compared at the same FPRs as the union of the HT experiments, which correspond to an LR cutoff 120 for yeast and an LR cutoff 15,000 for human.

FIG. 13: PPAR-γ interacts with LXR-β, PAX7, PDX1, and NKX2-2, but not with HHEX and CREB. HEK-293T cells transfected with plasmids expressing indicated tagged proteins were lysed and cell lysates and anti-Flag or anti-HA immunoprecipitations were immunoblotted with indicated antibodies. The co-immunoprecipitations of 3xFlag-tagged PPAR-γ (Flag-PPARγ) with HA-tagged LXRβ (HA-LXRβ, A), HA-tagged PAX7 (HA-PAX7, B), HA-tagged PDX1 (HA-PDX1, C), or HA-tagged NKX2-2 (HA-NKX2-2, C) respectively, were detected, indicating that PPAR-γ interacts with LXRβ, PAX7, PDX1, and NKX2-2. The co-immunoprecipitations of 3xFlag-tagged PPAR-γ with HA-tagged HHEX (HA-HHEX, D), or endogenous CREB (E) were not detected.

FIG. 14: SOCS3 interacts with GRB2, RAF1, and BTK, but not with NCK1. HEK-293T cells transfected with plasmids expressing indicated tagged proteins were lysed, immunoprecipitated with the anti-Flag or anti-HA antibodies, and immunoblotted with the indicated antibodies. The co-immunoprecipitations of HA-tagged SOCS3 (HA-SOCS3) with 3xFlag-tagged GRB2 (3xFlag-GRB2, Panel A), RAF1 (3xFlag-RAF1, Panel B), or BTK (3xFlag-BTK, Panel C) respectively, were all detected, indicating that SOCS3 interacts with GRB2, RAF1, and BTK. The co-immunoprecipitation of HA-tagged SOCS-3 with 3xFlag-tagged NCK1 (3xFlag-NCK1, Panel D) was not detected.

FIG. 15: Protocadherins interact with kinases ROR2, VEGFR2, ABL1 and RET. The wild-type and a cytoplasmic domain deletion mutant of PCDH-α4 interact with ROR2 (A) and VEGFR2 (D). Phe 64 of the Ig domain of ROR2 is important for the interaction between PCDH-α4 and ROR2 (B and C); the full length protein and the cytoplasmic domain of PCDH-α4 interact with ABL (E); PCDHγ interacts with ABL1 (F) and RET (G) in vivo. (A, C-E) HEK293 cells were transfected with a plasmid expressing full length mouse TAP-PCDH-α4 (TAP-PCDHα4 FL), a plasmid lacking the entire cytoplasmic domain (TAP-PCDHα4 ΔCD) or a plasmid expressing the only cytoplasmic domain (TAP-PCDHα4 CD), along with a plasmid expressing HA tagged mouse ROR2 (HA-ROR2, A and C), VEGFR2 (HA-VEGFR2, D), or ABL1 (HA-ABL1, E). The TAP tag includes of one HA epitope tag, followed by two tobacco etch virus (TEV) cleavage sites and two Flag tags. Total cell lysates and anti-Flag IPs were blotted with anti-Flag antibodies or specific antibodies against ROR2, VEGFR2, or ABL1 proteins respectively. The co-immunoprecipitation figures in these panels show that the full length PCDH-α4 and its cytoplasmic domain deletion mutant, but not its cytoplasmic domain interact with ROR2 (A) and VEGFR2 (D) and the full length PCDH-α4 and its cytoplasmic domain, but not its cytoplasmic domain deletion mutant interact with ABL1 (E). (B) The structural model for the interaction formed between the cadherin (CA) domain of PCDH-α4 and the Ig domain of ROR2, obtained by superimposing the homology models of the PCDH-α-4-CA domain (green) and the ROR2-Ig domain (purple) onto the template complex of the MN-cadherin EC1 domain homodimer (PDB code: 1zvn A and B chain, shown in blue and red respectively). Residue phenylalanine 64 (Phe64) of the ROR2-Ig domain is highlighted in sphere form. The co-immunoprecipitation figure in C shows that mutating F64 to another hydrophobic residue, alanine (F64A), has no detectable effect on the binding while mutating it to charged residues (F64E: glutamic acid, F64R: arginine, F64D: aspartic acid) significantly weakens the interaction. In F and G, crude membrane lysates from wild type or pcdhγ_{del/del} mice (mice lacking the protocadherin gamma gene cluster) were used for immunoprecipitations with anti ABL1 or RET antibodies and blotted for protocadherin with anti-pan PCDH antibodies. The co-immunoprecipitation figures in these panels show that PCDHγ interacts with ABL1 (Panel F) and RET (Panel G) in vivo.

FIG. 16: PRPF19 interacts with BMI1, but not with CUL4A; and SATB2 interacts with RCOR1 and SMARCC2. HEK-293T cells transfected with plasmids expressing indicated tagged proteins were lysed and cell lysates and anti-HA immunoprecipitations were immunoblotted with indicated antibodies. The co-immunoprecipitation of 3×HA-tagged PRPF19 (HA-PRPF19) with 3xFlag-tagged BMI1 (Flag-BMI1, A) was detected, indicating that PRPF19 interacts with BMI1; the co-immunoprecipitation of HA-PRPF19 and 3xFlag-tagged CUL4A was not detected (Flag-CUL4A, B). The co-immunoprecipitations of 3×HA-tagged SATB2 (HA-SATB2) with 3xFlag-tagged RCOR1 (Flag-RCOR1, C) or 3xFlag-tagged SMARCC2 (Flag-SMARCC2, D) were detected, indicating that SATB2 interacts with RCOR1 and SMARCC2. BMI1 and CUL4A are two components of the centromere chromatin complex (CEN complex), and RCOR1 and SMARCC2 are two components of the Emerin “proteome” complex 32, according to the CORUM database (http://mips.helmholtz-muenchen.de/genre/proj/corum, see reference [7].

FIG. 17: VHL interacts with EEF1D. HEK-293T cells transfected with plasmids expressing indicated tagged proteins were lysed and cell lysates and anti-Flag and anti-HA immunoprecipitations were immunoblotted with indicated antibodies. The co-immunoprecipitation of 3xFlag-tagged EEF1D (Flag-EEF1D) and 3×HA-tagged VHL (HA-VHL) indicates the two proteins interact. EEF1D and VHL were indicated to interact in a high-throughput mass spectroscopy study, although the score is low.

FIG. 18: Discriminating human PPIs involving members of the same protein family. Panels A-B plot LRs for all pairs of possible interactions between the four sets of proteins indicated. This figure addresses the question of whether the scoring of interaction models distinguish closely related proteins that form complexes from those that do not. Panel A indicates that there is a wide distribution of LRs resulting from SM alone even when comparing potential complexes involving proteins with very similar global structures (i.e., all SH2 domains). This discrimination results in large part from differences in the interface resulting, for example, from differences in hydrophobicity and sequence conservation between proteins that dimerize and proteins that do not. Panel B indicates that PrePPI provides an even greater spread of LRs, indicating that non-structural clues, such as co-expression, combined with SM-based clues, provide even greater discrimination among putative PPIs. Panels C-D show a correlation between SM (C) and PrePPI (D) scores and the probability of a PPI being known interaction (i.e., in any of the five databases of human PPIs as of August, 2011). (Note that in all cases, “probability of being known interaction” is not calculated for those bins with less than 20 predictions). This figure demonstrates that for four distinct sets of interactions the PrePPI scoring scheme provides a significant measure of specificity.

FIG. 19: Contributions of homology models (HM) and remote structural homologs to structural modeling and PrePPI performance for human proteins. A (SM alone) and B (PrePPI) report the distributions of LRs resulting from the exclusive use of PDB structures to derive interaction models for complexes and in the exclusive use of homology models. Overall, there are many more interaction models generated from homology models than from PDB structures but, crucially, this remains true even for high confidence (i.e., high LR) predictions. C-D indicate that a PDB structure provides a higher probability of reproducing a known interaction (i.e., interaction in any of the five databases of human PPIs as of August, 2011) than a homology model but that homology models alone also recover a significant number of database interactions. (Note that in all cases, “probability of being known interaction” is not calculated for those bins with less than 20 predictions). Interaction models using homology models are less reliable in identifying database PPIs than those generated from PDB structures, even when the LR is the same. This can partly be due to the possibility that proteins with known PDB structures are better studied and are thus more likely to appear in the database data set and that many high LR predictions based on homology models can eventually turn out to be correct but have not yet been studied. Panels E-H analyze the contribution of remote structural homologs to structural modeling and PrePPI performance. Structural homologs were divided into three categories (close structural similarity to the template proteins: PSD<=0.1; intermediate similarity: 0.1<PSD<0.4; and remote similarity: PSD>=0.4. Structural classification databases, like SCOP, can be used to define close and remote structural relationships but many protein structures do not have SCOP annotations. As the structural distance from the template increases more models are generated but these tend to have lower LRs, although a significant number of database interactions are recovered even based on remote structural homology (E). This number is increased dramatically when the full PrePPI score is used (F) due to the effects of combining different sources of evidence. Panels G-H show that for a given LR, remote homologs are about as effective as close homologs in recovering database interactions.

FIG. 20: The PrePPI page of predicted protein-protein interactions for query protein P03989.

FIG. 21: The structural interaction model for TGFβ receptor type I (green, UniProt ID P36897) and complement component C1q receptor (cyan, UniProt ID Q9NPY3) based on the structure of a designed protein (gold and red for A and B chains respectively of PDB file 1jy4).

FIG. 22: Schematic representation of a molecular interaction identification system in one embodiment of the disclosed subject matter.

### DETAILED DESCRIPTION

The systems and methods of the present disclosure are based on an algorithm that exploits both global and local structural similarity and uses Bayesian statistics to combine structural and non-structural evidence (e.g., co-expression) to predict protein-protein interactions (PPIs). In some embodiments, approximate models of potentially interacting protein pairs are constructed by superposing each on structurally similar proteins that interact in a database, such as the Protein Data Bank (PDB). In some embodiments, a structural BLAST approach is used for the identification of structurally similar proteins, allowing for the detection of remote relationships that contain valuable evidence for an interaction. Given the large numbers of interaction models that are generated in this way (tens of millions for yeast and billions for human), an important component of the presently disclosed methods and systems is the way in which these models are evaluated. Rather than assigning a score to a three-dimensional model, a set of empirical properties is defined using the structure-based sequence alignment between the query and template proteins. A Bayesian approach is then used to ascertain how well these properties correlate with being a true interaction based on reference sets of true positive and true negative interactions that have been compiled.

The methods and systems disclosed herein can reliably predict protein-protein interactions on a genome-wide scale. Overall, the systems and methods described herein provides results that are comparable to high-throughput experimental methods. Distinct from high-throughput experiments, the methods and systems described herein also provide a structural model for the interaction that can be tested and refined.

The methods and systems disclosed herein differs from other protein-protein interaction PPI databases based on several features: they provide structural information for many more interactions than has previously been possible using structure-enabled approaches and databases; predicted PPIs are obtained by combining structural and non-structural information; the methods and systems disclosed herein, including the software contains integrative information of PPIs from major PPI databases, and provides a Bayesian measure as to the confidence level of these interactions; and the software disclosed herein assign a single probability for each interaction using a Bayesian framework that combines quantitative results based on computational predictions with evidence contained in publically available databases.

### Description of the Method and Systems of the Disclosure

The present subject matter relates to methods and systems for predicting molecular interactions that utilize homology and remote geometric relations and structural information to predict protein-protein interactions. The methods of the present subject matter include combining structural and non-structural interaction clues or data points using Bayesian statistics to determine the likelihood of a predicted protein-protein interaction. The following description is given only for illustration, and it not intended to limit the present subject matter.

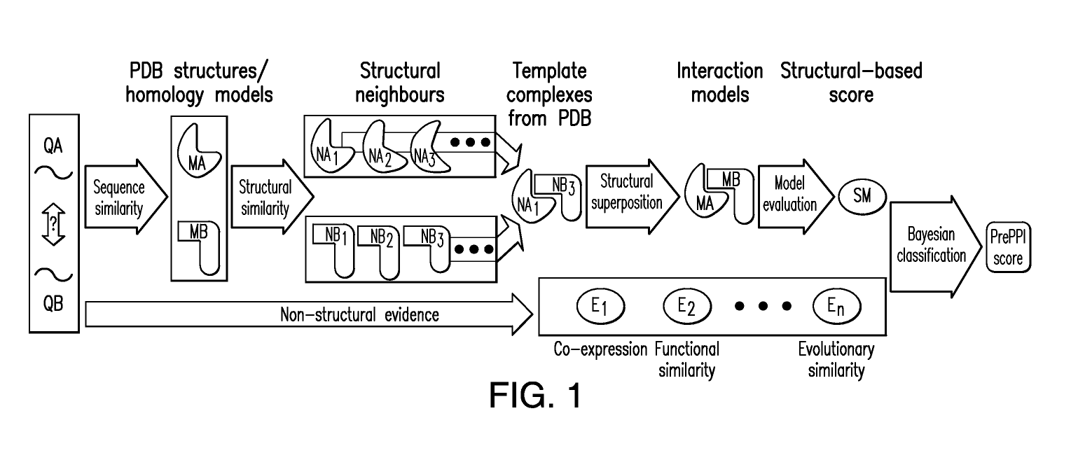

With reference to FIG. 1, in one aspect, the presently disclosed methods provide for identifying structural representatives (MA and MB) of a query protein (QA and QB). The query protein (also referred to herein as a query target), refers to an entire (full-length) query protein or one or more portions (protein domains) of a query protein.

Structural representatives can be identified in a database including, but not limited to, the Protein Data Bank (PDB)⁸ or the ModBase⁹, SWISS-MODEL¹⁰ and SkyBase¹⁵ homology model databases, using sequence homology. Identification of sequence homology between a query target and a structural representative can be carried out using any known method for identifying sequence homology, such as, for example, BLAST.

As used herein, the percent homology between two amino acid sequences is equivalent to the percent identity between the two sequences. The percent identity between the two sequences is a function of the number of identical positions shared by the sequences (i.e., % homology=# of identical positions/total # of positions×100), taking into account the number of gaps, and the length of each gap, which need to be introduced for optimal alignment of the two sequences. The comparison of sequences and identification of sequence homology between a query target and a structural representative can be accomplished using a mathematical algorithm, as described in the non-limiting examples below.

The percent identity between two amino acid sequences can be determined using the algorithm of E. Meyers and W. Miller¹¹ which has been incorporated into the ALIGN program (version 2.0), using a PAM120 weight residue table, a gap length penalty of 12 and a gap penalty of 4. In addition, the percent identity between two amino acid sequences can be determined using the Needleman and Wunsch algorithm¹² which has been incorporated into the GAP program in the GCG software package (available at www.gcg.com), using either a Blossum 62 matrix or a PAM250 matrix, and a gap weight of 16, 14, 12, 10, 8, 6, or 4 and a length weight of 1, 2, 3, 4, 5, or 6.

The query target can be used to perform a search against public databases to identify structural representatives. Such searches can be performed using the XBLAST program (version 2.0)¹³ of Altschul, et al. (1990). BLAST protein searches can be performed with the XBLAST program, score=50, word length=3 to obtain amino acid sequences homologous to a query target. To obtain gapped alignments for comparison purposes, Gapped BLAST can be utilized as described¹⁴ in Altschul et al., (1997). When utilizing BLAST and Gapped BLAST programs, the default parameters of the respective programs (e.g., XBLAST and NBLAST) can be used. (See www.ncbi.nlm.nih.gov).

Representative structures can be identified as having greater than about 85%, 85%, 87%, 88%, 89%, 90%, 91%, 92%, 93%, 94%, 95%, 96%, 97%, 98%, 99%, or more sequence identity to the query target (the entire protein or any domain) over greater than about 80% or more of the query target (the entire protein or any domain). Homology models can be selected based on particular criteria, such as, for example: (1) an E value less than 1×10⁻⁶; or (2) an E value less than 1 and either a structure-based pG score ≧0.3, for SkyBase models¹⁵, or a ModPipe protein quality score (MPQS)≧0.5, for ModBase models.

If multiple structures are available for a protein or protein domain, a structural representative can be chosen based on the following criteria: (1) the PDB structure with the best resolution, if available; (2) the ModBase model with the highest MPQS score; and/or (3) the SkyBase model with the highest pG score.

The method further includes identifying structural neighbors (NAₓ and NBₓ in FIG. 1) of the structural representatives. Structural neighbors can be close structural neighbors or remote structural neighbors. The degree of similarity between two proteins can be defined in terms of its protein structural distance (PSD)¹⁶ with close defined as PSD<0.1, intermediate as 0.1<PSD<0.4 and remote as 0.4<PSD<0.6. The PSD reflects the degree to which the two proteins can be superimposed in 3-dimensional space.

In one embodiment, structural alignment, using the structural alignment tool Ska¹⁷ or any other suitable structural alignment tool, can be used to identify structural neighbors. Programs such as DALI¹⁸ and MAMMOTH¹⁹ and SSAP²⁰, among many others, can also be used. Whenever two of the identified structural neighbors of the two individual query proteins form a complex, for example in the PDB, a template is defined for modeling the interaction of the predicted protein-protein interaction between the two query proteins. Although the method is not limited to performing the structural alignment with Ska, the Ska tool allows alignments to be considered significant even if only three secondary structural elements are well aligned, leading to the identification of remote structural neighbors. It has been demonstrated that even distantly related proteins often use regions of their surface with similar arrangements of secondary structure elements to bind to other proteins²¹⁻²³, suggesting considerably expanding the number of putative PPIs that can be identified.

Using the identified structural neighbors, interaction models of the putative protein-protein complex can be formed by superimposing the representative structures on their corresponding structural neighbors in the template, as exemplified in FIG. 1. An interaction model represents the physical interaction between the two individual query proteins and identifies the potential amino acid residues of each query protein or protein subunit that contribute to the putative binding site.

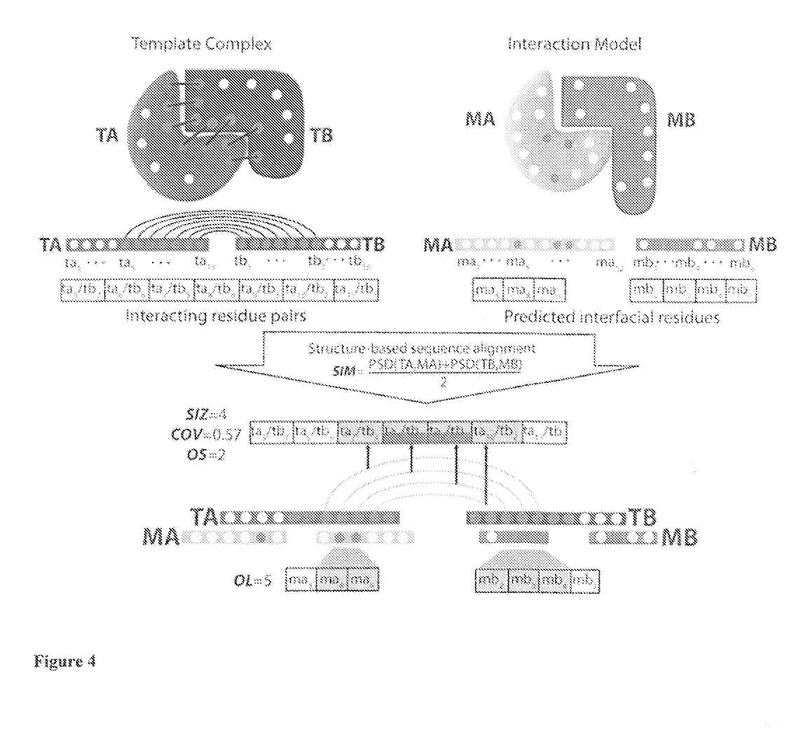

In another embodiment, the method further includes evaluating the interaction model using one or more structural-based scores that measure properties derived from structural alignments of the individual protein domains to their respective structural neighbors of the template complex (such scores can be designated as SIM, SIZ, COV, OS and OL; see FIG. 4). One structural-based score that can be determined is SIM, which evaluates the geometric similarity between modeled interaction of the two query proteins and the template complex.

SIM represents the geometric similarity between the protein domains in the template and the interaction model measured using protein structural distance (PSD¹⁶). As exemplified in FIG. 1, the individual domains (i.e., MA of QA and MB of QB) of the query proteins (QA and QB) that participate in the modeled interaction are aligned to their respective structural neighbors in the template complex (i.e., MA to TA and MB to TB) to calculate the structural-based score, SIM. Two geometric alignments can be obtained for each interaction model; therefore, SIM can be calculated as the average of PSD(TA,MA) and PSD(TB,MB).

Other structural based scores include SIZ and COV, which determine whether the interface in the template complex is found in the model. Specifically, SIZ is the number of interacting residue pairs in the template complex that are preserved in the interaction model, and COV is the fraction of interacting residue pairs in the template complex that are preserved in the interaction model. In the example shown in FIG. 4, four of the seven interacting pairs present in the template are preserved in the model (ta7/tb5, ta8/tb4, ta9/tb3, ta10/tb2, highlighted in grey and indicated by grey lines), resulting in a SIZ score of 4 and a COV score of 0.57.

Another set of scores can be obtained from predictions of interfacial residues, residues that reside at the interface of a protein-protein binding site, based on the sequence and structure of the individual protein domains of the interaction model. OS is the number of interacting residue pairs in the template complex that align to a predicted interfacial residue in the modeled interaction. As exemplified in FIG. 4, two of these interacting pairs (ta8/tb4 and ta9/tb3, highlighted in grey and blue) are present, where each residue in the pair also aligns to a predicted interfacial residue in the model, resulting in an OS score of 2.

OL is the number of predicted interfacial residues in the template complex that align with the predicted interfacial residues in the modeled interaction. As exemplified in FIG. 4, MA has 2 predicted interfacial residues that align to interfacial residues in TA (ma8 and ma9, highlighted in grey); MB has 3 interfacial residues that align to interfacial residues in TB, therefore resulting in an OL score of 5.

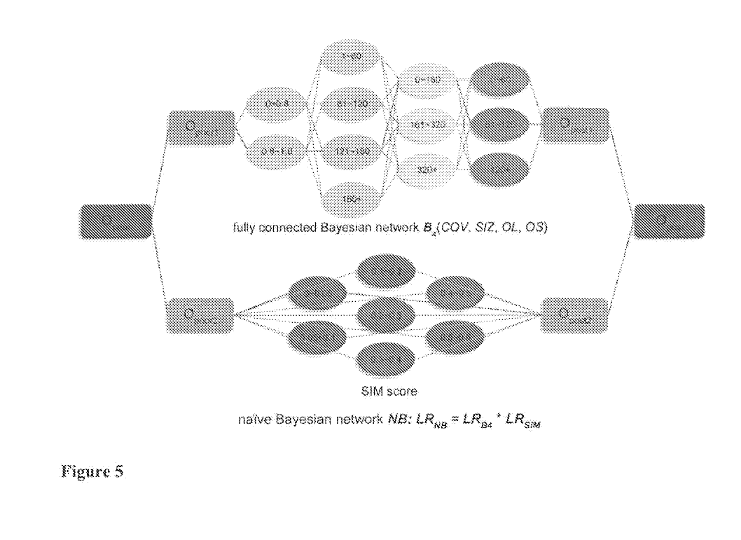

The method of the present disclosure further includes combining the one or more structure-based scores that were calculated for each model using a Bayesian network to determine a Likelihood Ratio (LR) to evaluate the interaction model (see FIG. 5). The Bayesian network can be trained on positive and negative reference data sets, where interaction data from multiple databases can be combined to ensure a broad coverage of true interactions. The interaction datasets can be further divided into high-confidence (HC) and low-confidence (LC) subsets (see Table 1, below).

Another embodiment of the disclosed method includes evaluating the predicted protein-protein interaction by analyzing one or more non-structural clues²⁴⁻²⁶(e.g., “non-structural evidence” as set forth in FIG. 1). Various sources of non-structural information can be examined. For example, a non-exhaustive list of non-structural clues that can be examined includes: (1) the essentiality of the proteins in the interacting pair, (2) co-expression level; (3) gene ontology (GO) functional similarity; and (4) MIPS (Munich Information Centre for Protein Sequences) functional similarity (4). A phylogenetic profile (PP) similarity can also be measured. Each non-structural clue can be evaluated using a Bayesian network to generate an LR.

The method further includes combining the structural and non-structural scores into a single naive Bayes PPI classifier^{6,24-26}:

$$LR ( {c}_{1} , {c}_{2} , … , {c}_{n} ) = {\prod }_{i = 1}^{n} LR ( {c}_{i} )$$

to determine whether a predicted protein-protein interaction represents a true interaction.

The identification of protein-protein interactions existent in an organism provides a powerful framework to study various biological concepts. The method of the present subject matter can be used to identify novel protein-protein interactions important to, for example, cancer biology and protein-drug modeling, among others.

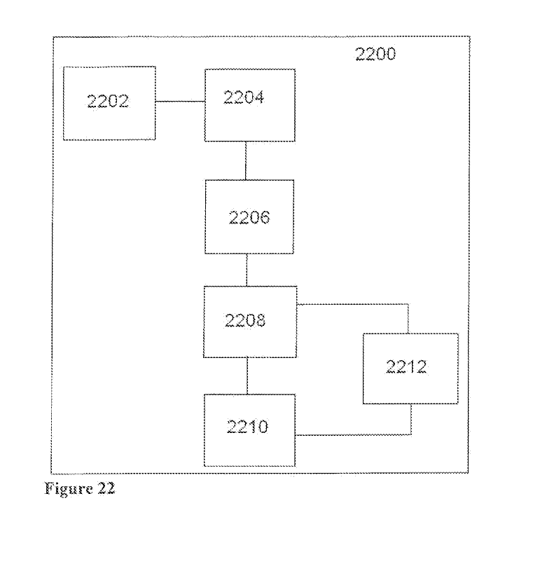

The disclosed subject matter also includes systems for identifying a molecular interaction between at least two query molecules. For purpose of explanation and illustration, and not limitation, an exemplary embodiment of the system for identifying a molecular interaction between at least two query molecules in accordance with the disclosed subject matter is shown in FIG. 22. The molecular interaction identification system 2200 can include a structural representatives generator 2202, an interaction modeler 2204, a structural-based score generator 2206, a structural-based score combination unit 2208, a non-structural based score generator 2210, and an interaction likelihood determination unit 2212.

The structural representatives generator 2202 can be configured to generate at least two structural representatives corresponding to the at least two query molecules. In accordance with one embodiment of the disclosed subject matter, the structural representatives generator is coupled to a user interface to allow a user to enter one or more query molecules. Any component described herein can be coupled to any other component either directly or indirectly through other components. The user interface can include a computer monitor, a keyboard, a mouse, a microphone and speech recognition software, or any other combination of hardware and software that allows the user to interact with the molecular interaction identification system 2200.

In accordance with another embodiment of the disclosed subject matter, the structural representatives generator 2202 can be coupled to a receiver, and the query molecules can be transmitted from a remote location to the structural representatives generator 2202 via the receiver. For example, the receiver can be connected to a communications network such as the Internet, and the query molecules can be transmitted from a remote client device to a molecular interaction identification system 2200 on a server.

The structural representatives generator 2202 can also be coupled to a storage device. The storage device can store a database such as the Protein Data Bank or the ModBase and SkyBase homology model databases. The structural representatives generator 2202 can identify sequence homology between a query target and a structural representative using any known method for identifying sequence homology such as, for example, BLAST. In accordance with another embodiment of the disclosed subject matter, the structural representatives generator 2202 can be coupled to a storage device having instructions stored thereon for identifying structural representatives. For example, the structural representatives generator 2202 can be coupled to a storage device storing the XBLAST program and/or the Gapped BLAST program.

The interaction modeler 2204 is coupled to the structural representatives generator 2202, and is configured to model an interaction between the at least two query molecules to generate a modeled interaction. The interaction modeler 2204 can be coupled to a storage device having a template complex stored thereon. The template complex can include at least two structural neighbors corresponding to the at least two query molecules. In accordance with one embodiment of the disclosed subject matter, the interaction modeler 2204 can include a structural alignment tool such as Ska. The structural alignment tool can be used to identify structural neighbors.

The structural-based score generator 2206 is coupled to the interaction modeler 2204, and is configured to generate one or more structural-based scores to assess the modeled interaction. In accordance with one embodiment of the disclosed subject matter, the structural-based score generator 2206 includes a geometric similarity determination unit for determining a geometric similarity between the modeled interaction and a template complex, an interacting residue pair preservation number determination unit for determining a number of interacting residue pairs in the template complex that are preserved in the modeled interaction, an interacting residue pair preservation fraction determination unit for determining a fraction of interacting residue pairs in the template complex that are preserved in the modeled interaction, an interacting residue pair alignment number determination unit for determining a number of interacting residue pairs in the template complex that align to a predicted interfacial residue in the modeled interaction, and an interfacial pair alignment number determination unit for determining a number of interfacial residues in the template complex that align with predicted interfacial residues in the modeled interaction. Structural-based scores that can be used in connection with the disclosed subject matter include, but are not limited to, SIM, SIZ, COV, OS, and OL.

The structural-based score combination unit 2208 is coupled to the structural-based score generator 2206, and is configured to combine the one or more structural-based scores into a combined structural-based score. In accordance with one embodiment of the disclosed subject matter, the structural-based score combination unit 2208 uses a Bayesian network. The Bayesian network can be a network trained on a positive and a negative interaction reference set. The structural-based score combination unit 2208 can be coupled to one or more storage devices having multiple databases stored thereon to ensure a broad coverage of true interactions. The positive and negative interaction reference sets can be divided into high-confidence and low-confidence subsets.

The non-structural-based score generator 2210 is coupled to the structural-based score combination unit 2208, and is configured to generate one or more non-structural-based scores to assess the modeled interaction. In accordance with one embodiment of the disclosed subject matter, the non-structural-based score generator 2210 can be coupled to one or more storage devices having one or more databases stored thereon. Such storage devices can include data such as the essentiality of the proteins in the interacting pair, the co-expression level, the gene ontology (GO) functional similarity, and the MIPS functional similarity.

The interaction likelihood determination unit 2212 is coupled to non-structural-based score generator 2210 and the structural-based score combination unit 2208, and is configured to determine a likelihood that the modeled interaction represents a true interaction from the combined structural-based score and the one or more non-structural based score. In accordance with one embodiment of the disclosed subject matter, the interaction likelihood determination unit 2212 can be a Naïve Bayesian classifier based on the structural and non-structural scores.

The structural representatives generator 2202, the interaction modeler 2204, the structural-based score generator 2206, the structural-based score combination unit 2208, the non-structural based score generator 2210, and the interaction likelihood determination unit 2212 of the molecular interaction identification system 2200 can be implemented in a variety of ways as known in the art. For example, each of the functional units can be implemented using an integrated single processor. Alternatively, each functional unit can be implemented on a separate processor. Therefore, the molecular interaction identification system 2200 can be implemented using at least one processor and/or one or more processors.

The at least one processor includes one or more circuits. The one or more circuits can be designed so as to implement the disclosed subject matter using hardware only. Alternatively, the processor can be designed to carry out the instructions specified by computer code stored in a hard drive, a removable storage medium, or any other storage media. Such non-transitory computer readable media can store instructions that, upon execution, cause the at least one processor to perform the methods as disclosed herein.

The molecular interaction identification system 2200 can further include additional components in accordance with the disclosed subject matter.

The disclosed subject matter further includes a non-transitory computer readable medium. The non-transitory computer readable medium includes a storage device. The storage device can include a hard drive, a removable storage medium, or any other storage media. The storage device can be, for example, an optical disk, a CD-ROM, a magneto-optical disk, ROM, RAM, EPROM, EEPROM, magnetic or optical cards, flash memory, or any other non-transitory computer readable medium. The computer readable medium stores machine-readable instructions that cause one or more processors to perform the methods disclosed herein.

The following examples are offered to more fully illustrate the disclosure, but are not to be construed as limiting the scope thereof.

### EXAMPLES

### Example 1

### Structure-Based Prediction of Protein-Protein Interactions on a Genome-Wide Scale

Three-dimensional structural information can be used to predict PPIs with an accuracy and coverage that are superior to predictions based on non-structural evidence. An algorithm, termed PrePPI, which combines structural information with other functional clues, is comparable in accuracy to high-throughput experiments, yielding over 30,000 high-confidence interactions for yeast and over 300,000 for human.

Until now, structural information has had relatively little impact in constructing protein-protein interactomes, primarily because there is a marked difference between the number of proteins with known sequences and those with an experimentally known structure. For example, as of early 2010, the Protein Data Bank (PDB) provided structures for ˜600 of the total complement of ˜6,500 yeast proteins (˜10%), while the structural coverage of protein-protein complexes is even more sparse, with only about 300 structures available out of the approximately 75,000 PPIs (<0.5%) recorded in publically available databases. However, ˜3,600 additional yeast proteins have homology models in either the ModBase⁹ or SkyBase¹⁵ databases. Moreover, there were about 37,000 protein-protein complexes derived from multiple organisms in the PDB and Protein Quaternary Structure²⁷ (PQS) databases, which can be used as ‘templates’ to model PPIs. If structure is to be useful on a large scale, it is essential that modeling of individual proteins and complexes be exploited.

A number of studies have used structurally characterized complexes as templates to construct models of the complexes that can be formed between proteins that have been classified as having sequence and/or structural relationships to the proteins in the template²⁸⁻³⁰. In this Example, templates were searched for more broadly, using geometric relationships between groups of secondary structure elements as revealed by structural alignment, independently of how they are classified. It has been demonstrated that even distantly related proteins often use regions of their surface with similar arrangements of secondary structure elements to bind to other proteins³¹⁻³³, indicating considerably expanding the number of putative PPIs that can be identified.

### METHODS

### Proteins and Domains

The yeast proteome was obtained from UniProt³⁴, and its 6,521 proteins were parsed into 7,792 domains using the SMART online server³⁵. Similarly, for human, 20,318 unique proteome members were identified, producing 49,851 individual domains.

### Structural Representatives

Structural representatives of the entire protein or different individual domains were either taken directly from the PDB³⁶, where available, or from the ModBase⁹ and SkyBase¹⁵ homology model databases. PDB structures were identified by sequence homology, using a single iteration of PSI-BLAST³⁷ and an E-value cutoff 0.0001; matching structures in the PDB were required to have >90% sequence identity and cover >80% of the query target (the entire protein or any domain). Homology models were selected based on two criteria: (1) an E value less than 1×10⁻⁶; or (2) an E value less than 1 and either a structure-based pG score ≧0.3, for SkyBase models¹⁵, or a ModPipe protein quality score (MPQS)≧0.5, for ModBase models. When multiple structures were available for a target/domain only one representative was chosen using: (1) the PDB structure with the best resolution, if available; (2) the ModBase model with the highest MPQS score; or (3) the SkyBase model with the highest pG score. On the basis of these criteria, 1,361 PDB structures and 7,222 homology models for 4,193 different yeast proteins were identified. Among these, 627 proteins can be matched to a PDB structure and 3,662 to a homology model, with some proteins having both. For human, 14,132 proteins were matched to 8,582 PDB structures and 30,912 models. Specifically, 4,286 proteins were matched to a PDB structure and 11,266 were matched to a homology model, with some proteins matched to both.

### Structural Neighbors

The structural alignment tool Ska³⁸ was used to identify structural neighbors. Ska allows alignments to be considered significant even if only three secondary structural elements are well aligned. At a protein structure distance³⁹ (PSD) cutoff of 0.6, 1,448 neighbors (both close and remote) were identified per structure for 7,875 structures of 3,911 yeast proteins, and 1,553 neighbors per structure for 36,743 structures of 13,545 human proteins.

### Template Complexes

As of February 2010, there were about 37,000 protein-protein complexes involving multiple organisms in the PDB and PQS⁴⁰ databases. 28,408 and 29,012 complexes were used as templates during the modeling of yeast and human interactions, respectively. PQS terminated updates after August 2009, and has been replaced by the protein interfaces, surfaces and assemblies (PISA) server⁴¹.

### Interaction Modeling

Given a pair of proteins or domains, their interaction model was built by superimposing their structures with the corresponding structural neighbors in the templates (see FIG. 1). For yeast, 550 million models were built for 2.4 million potential PPIs, and for human, 12 billion models for 36 million potential PPIs were built. Five structure-based scores were calculated for each model (see FIG. 4) and a Bayesian network was used to combine these scores into an LR to evaluate an interaction model (see FIG. 5) based on the HC and the N reference sets (see Table 1).

### Training of the Bayesian Network

The training and evaluation of a PPI predictor requires accurate and broad coverage gold standards for both positive and negative interactions. Yet, achieving these competing goals can pose significant challenges. Some studies have used a single, well-annotated database⁴² but bias in individual databases has been described which can complicate evaluation of the method⁴³. On the other hand, the use of all available data can also be problematic because of issues related to the accuracy of databases that incorporate interactions determined, for example, by high-throughput approaches⁴⁴.

Similar to two recent studies of the yeast and human B-cell interactomes^{45,46}, interaction data from multiple databases were combined and the reliable ones were selected to ensure accurate and broad coverage of true interactions in the positive reference set. For yeast, interactions databases: MIPS⁴⁷, DIP⁴⁸, BioGRID⁴⁹, IntAct⁵⁰ and MINT⁵¹ were used. Data deposited prior to August 2009 was retrieved. For human, the databases: HPRD⁵², DIP, BioGRID, MINT and IntAct were used, retrieving data deposited prior to August 2010. Different protein identifiers were mapped to UniProt accession numbers (AC) and used the pairs of accession numbers as the unique identifiers to all PPIs. Proteins without valid UniProt AC or not defined in the yeast and the human proteomes were removed (i.e., resulting in a total of 6,521 proteins for yeast and 20,318 proteins for human). The high confidence (HC) reference set for yeast contains 11,851 interactions with more than one supporting publication and the low confidence (LC) reference set contains 61,936 interactions with only one supporting publication (73,787 in total). The HC set for human contains 7,409 unique interactions, and the LC set contains 51,363 interactions (58,772 in total). All the HC and the LC datasets are available at http://bhapp.c2b2.columbia.edu/PrePPI/downloads.html. In Table 1, cells on the diagonal represent the number of interactions taken from the corresponding database and the off-diagonal cells show the overlap between different data sources.

### Non-Structural Clues

For the yeast proteome, raw data for four different clues was downloaded; protein essentiality (ES), co-expression (CE), GO⁵³³ similarity, and MIPS⁴⁷ similarity, from the Gerstein laboratory (http://networks.gersteinlab.org/intint/supplementary.htm). A measure of phylogenetic profile (PP) similarity was also measured as previously described⁵⁴. An LR for each non-structure clue was calculated based on HC and N reference sets. For the human proteome, three different clues were calculated following the protocol described in reference [55] for GO and CE, and as described below for PP. For CE, the expression data set (GDS1962) was used, which is one of the most comprehensive microarray studies of 19,803 human genes under 180 different conditions⁵⁶, from the Gene Expression Omnibus⁵⁷.

### Phylogenetic Profile Similarity

Using a similar method to that previously described⁵⁸, a continuous score between 0 and 1 was calculated to measure the occurrence of a protein and/or domain in 1,156 reference organisms of complete proteome information from UniProt. These scores form a phylogenetic profile vector (PPV), and the Pearson correlation coefficient (PCC) was used to define the similarity between two vectors. For proteins with multiple domains, each domain's PPV is calculated independently, and the highest PCC score of different domain pairs is selected as the similarity score between two proteins. Similarity scores for pairs of proteins/domains with >40% sequence identity and, of course, for homomeric protein/domain pairs were not calculated. The Naive Bayes Classifier

Different types of non-structural clues were combined the structural modeling (SM) clues (i.e., SIM, SIZ, COV, OS, and OL) into a single naive Bayes PPI classifier²⁴⁻²⁶:

$$LR ( {c}_{1} , {c}_{2} , … , {c}_{n} ) = {\prod }_{i = 1}^{n} LR ( {c}_{i} )$$

### Tenfold Cross Validation

The positive and negative reference sets were randomly divided into ten subsets of equal size. Each time, nine subsets were used to train the classifier, and obtained the LR for each protein pair, that is, interaction, in the excluded subset from the trained classifier. The procedure was repeated ten times using different subsets as training and testing data sets and finally obtained an LR for each interaction. The number of true positives (predictions in the HC set) and false positives (predictions in the N set) were counted and calculated the prediction TPR (true positive rate)=TP/(TP+FN), and the FPR (false positive rate)=FP/(FP+TN), to plot the ROC curves. In all cases, structural interaction models based on a template that corresponds to an actual crystal structure of the two target proteins were removed.

Comparison with High-Throughput Experiments

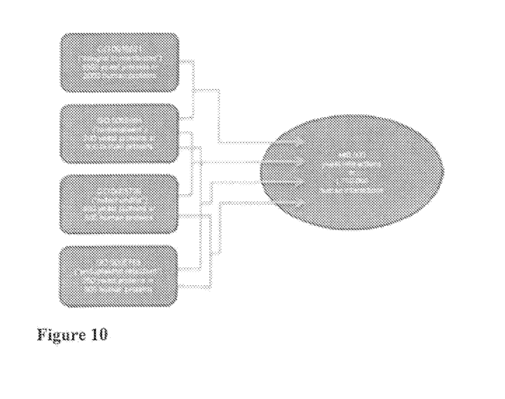

Eight high-throughput experiment data sets for yeast and three for human were retrieved (See Table 4). In the comparison, in addition to the HC sets, the reference interaction sets from a comparative study of different high-throughput techniques were also used⁵⁹. These include ˜1,300 PPIs (CCSB-BGS) and a subset of 188 highly reliable PPIs that are referenced in at least four manuscripts (CCSB-PRS). A new negative reference set was compiled, which consists of 440,000 yeast and 1,750,000 human protein pairs in which each protein in a pair is annotated as localized to a different cellular compartment (See FIG. 10).

### New Protein Interaction Data Set

23,779 human protein interactions newly deposited into databases after August 2010 were used as independent validations of PrePPI predictions, which were based on pre-2010 data (See Table 5).

### Results

The prediction of PPIs is embodied in an algorithm named PrePPI (predicting protein-protein interactions), which combines structural and non-structural interaction clues using Bayesian statistics (see FIG. 1 and Methods). The structural component of PrePPI involves a number of processes (see FIG. 1). Briefly, given a pair of query proteins (QA and QB), sequence alignment was used to identify structural representatives (MA and MB) that correspond to either their experimentally determined structures or to homology models. Structural alignment was then used to find both close and remote structural neighbors (NAᵢ and NBⱼ) of MA and MB (an average of ˜1,500 neighbors are found for each structure). Whenever two (for example, NA₁ and NB₃) of the over 2 million pairs of neighbors of MA and MB form a complex reported in the PDB, this defines a template for modeling the interaction of QA and QB. Models of the complex are created by superimposing the representative structures on their corresponding structural neighbors in the template (that is, MA on NA₁ and MB on NB₃). This procedure produces about 550 million ‘interaction models’ for about 2.4 million PPIs involving about 3,900 yeast proteins, and about 12 billion models for about 36 million PPIs involving about 13,000 human proteins. An interaction model is based on structure-based sequence alignments of query proteins to their individual templates (FIG. 4) and a three-dimensional model of each complex is not constructed because the scoring of so many individual complexes would be prohibitively time consuming using standard energy functions (for example, as used in docking⁶⁰).

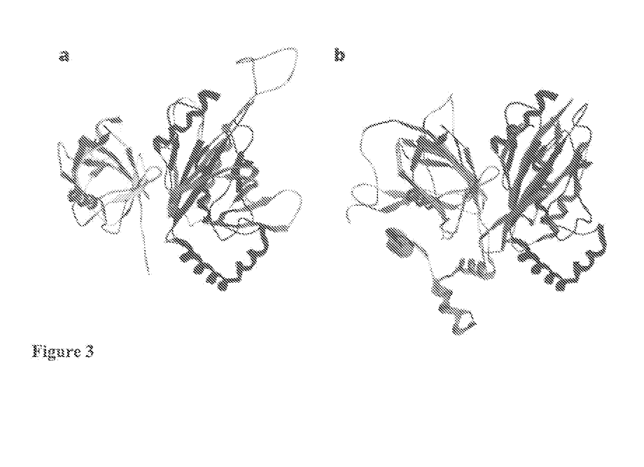

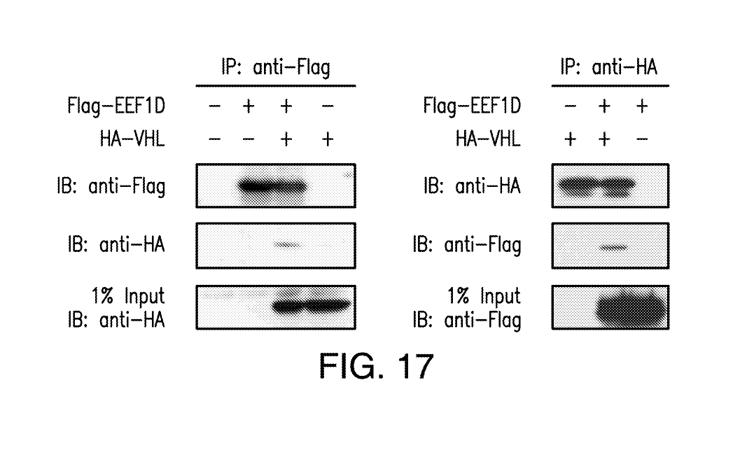

Two examples of the use of remote structural relationships and homology models are shown in FIG. 3. An HC set interaction of serine/threonine-protein kinase D1 (PRKD1) and protein kinase C-ε (PRKCE) is recovered by structural modeling using a complex of two proteins in the ubiquitin pathway (not kinases) as template (FIG. 3a). Note that PRKD1 and PRKCE are not sequence homologues of the two corresponding ubiquitin pathway proteins and are classified as belonging to different SCOP folds. However, the interaction model has a significant SM score (LR=130) arising from both local structural similarity and a conserved interface. A prediction of an LC set interaction between the elongation factor 1-δ (EEF1D) and the von Hippel-Lindau tumour suppressor (VHL) using the same template as that used in FIG. 3a is shown in FIG. 3b. Again, there is no sequence relationship between the target and the template proteins, and they are classified into different SCOP folds. Nevertheless, the interaction model has an LR of 70. It is noted that the EEF1D and VHL were found to interact using mass spectroscopy⁶¹ and by co-immunoprecipitation experiments (see FIG. 17).

Once an interaction model has been created, it is evaluated using a combination of five empirical scores that measure properties derived from alignments of the individual monomers to their templates (FIG. 4). The first score, SIM, depends on the structural similarity between models of the two query proteins (that is, MA and MB) and those in the template complex (that is, NA₁ and NB₃). The next two scores determine whether the interface in the template complex actually exists in the model. They are calculated as SIZ, the number, and COV, the fraction, of interacting residue pairs in the template (for example, NA₁-NB₃) that align to some pair of residues in the model (MA-MB). The final two scores reflect whether the residues that appear in the model interface have properties consistent with those that mediate known PPIs (for example, residue type, evolutionary conservation, or statistical propensity to be in protein-protein interfaces). This information is obtained from three publically available servers that predict interfacial residues based on the sequence and structure of the individual subunits or domains of the model⁶²⁻⁶⁴. These scores are calculated as OS, which is identical to SIZ but with the additional requirement that both residues in an interacting pair of the template align to predicted interfacial residues in MA and MB, and OL, the number of template interfacial residues that align to predicted interfacial residues in MA and MB. Although the interaction models produced by this procedure can reveal the approximate locations of potential interfaces, they will not, in general, be accurate at atomic resolution.

The five empirical scores are combined using a Bayesian network (FIG. 5) to yield a likelihood ratio (LR) that a candidate protein-protein complex represents a true interaction (see Methods). Based on a calculation of the Pearson correlation coefficients for each pair of scores using all 550 million models built for yeast, COV, SIZ, OL, and OS were correlated with each other but SIM was only weakly correlated with the other four. The network is trained on positive and negative ‘gold standard’ reference data sets. Similar to two recent studies^{65,66}, interaction data from multiple databases was combined to ensure a broad coverage of true interactions. The interaction datasets are divided into high-confidence (HC) and low-confidence (LC) subsets (see Table 1); the HC sets contain 11,851 yeast interactions and 7,409 human interactions that have more than one publication supporting their existence; interactions with only one supporting publication compose the LC set. All potential PPIs in a given genome not in the HC plus LC set form the negative (N) reference set. Using the Bayesian network classifier trained on the yeast HC set, the best interaction model with the highest LR is used for each PPI.

TABLE 1
Positive PPI reference sets for yeast and human.

| | | | | | |
|---|---|---|---|---|---|
| Database | DIP | IntAct | MINT | BioGRID | Overall |

(A) Yeast

| | | | | | | |
|---|---|---|---|---|---|---|
| | MIPS | | | | | |
| MIPS | 7,539 | 6,955 | 6,379 | 6,349 | 3,910 | 7,539 |
| DIP | | 17,511 | 13,305 | 12,731 | 13,149 | 17,511 |
| IntAct | | | 48,009 | 16,680 | 19,316 | 48,009 |
| MINT | | | | 24,083 | 17,082 | 24,083 |
| BioGRID | | | | | 42,650 | 42,650 |
| Overall | | | | | | 73,787 |

(B) Human

| | | | | | | |
|---|---|---|---|---|---|---|
| | HPRD | | | | | |
| HPRD | 14,977 | 319 | 4,266 | 3,264 | 7,316 | 14,977 |
| DIP | | 1,460 | 430 | 352 | 706 | 1,460 |
| IntAct | | | 27,911 | 7,235 | 11,357 | 27,911 |
| MINT | | | | 12,099 | 5,044 | 12,099 |
| BioGRID | | | | | 32,071 | 32,071 |
| Overall | | | | | | 58,772 |

To assess quantitatively the performance of structural modeling (SM), SM was compared with a number of non-structural clues previously used to infer PPIs²⁴⁻²⁶: (1) essentiality of the proteins in the interacting pair; (2) co-expression level; (3) gene ontology (GO) functional similarity; (4) MIPS (Munich Information Centre for Protein Sequences) functional similarity; and (5) phylogenetic profile similarity. The same algorithms or data for clues 1-4 were used, as previously described²⁵ but a phylogenetic profile algorithm was developed (for details, see Methods and Table 2). Briefly, a phylogenetic profile was constructed for every protein using a set of completely resolved proteomes as references. Because interacting proteins tend to co-evolve, proteins with similar profiles are predicted to interact.

TABLE 2
Availability of different clues for protein pairs in yeast.

| Method | predictions | Coverage | HC | recall |
|---|---|---|---|---|
| SM | 2398316 | 11.3% | 3063 | 25.8% |
| GO | 2756276 | 13.0% | 5036 | 42.5% |
| ES | 2925066 | 13.8% | 4787 | 40.4% |
| MIPS | 5962511 | 28.0% | 6915 | 58.3% |
| CE | 17967683 | 84.5% | 11118 | 93.8% |
| PP | 17848620 | 83.9% | 11273 | 95.1% |

Clues for GO similarity, protein essentiality (ES), MIPS similarity, and co-expression (CE) data were retrieved from reference [25]. ORF names were mapped to UniProt accession numbers and only those defined in the yeast proteome were kept (i.e., limited to 6,521 yeast proteins). Coverage is the number of protein pairs for which a given clue (structural modeling (SM), GO, ES, MIPS, CE, and phylogenetic profile (PP) similarity) is available, divided by the total number of possible interactions (21 million); recall is the number of protein pairs in our HC set for which a given clue is available divided by the number of interactions in the HC set (11,851).

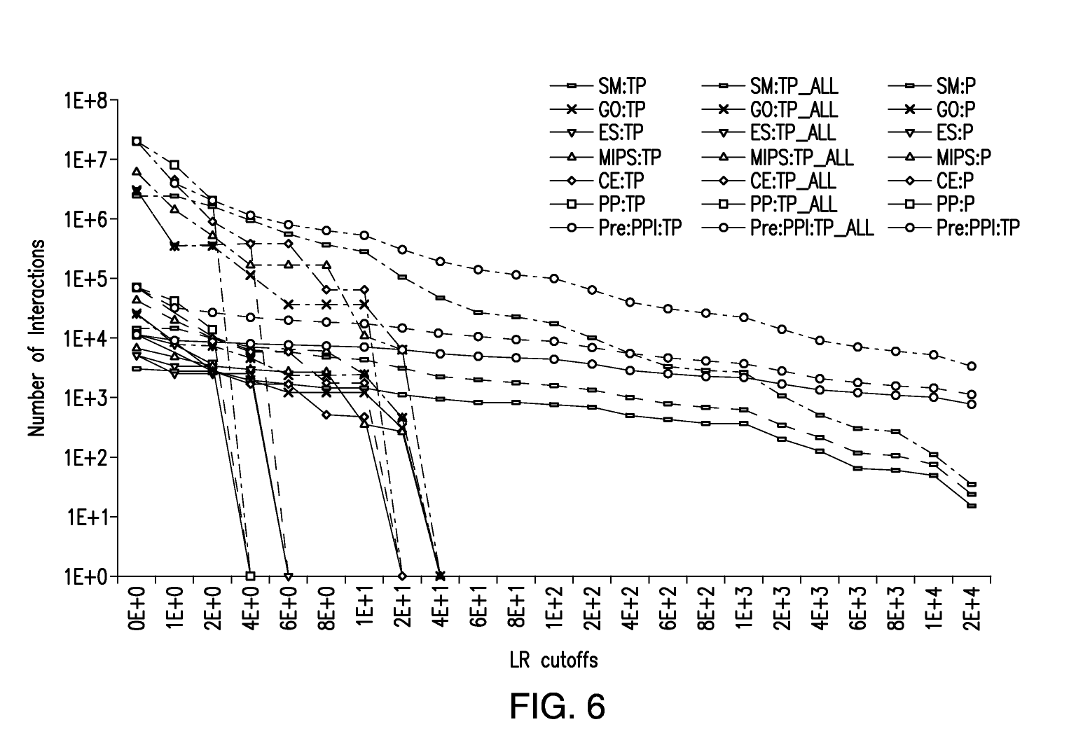

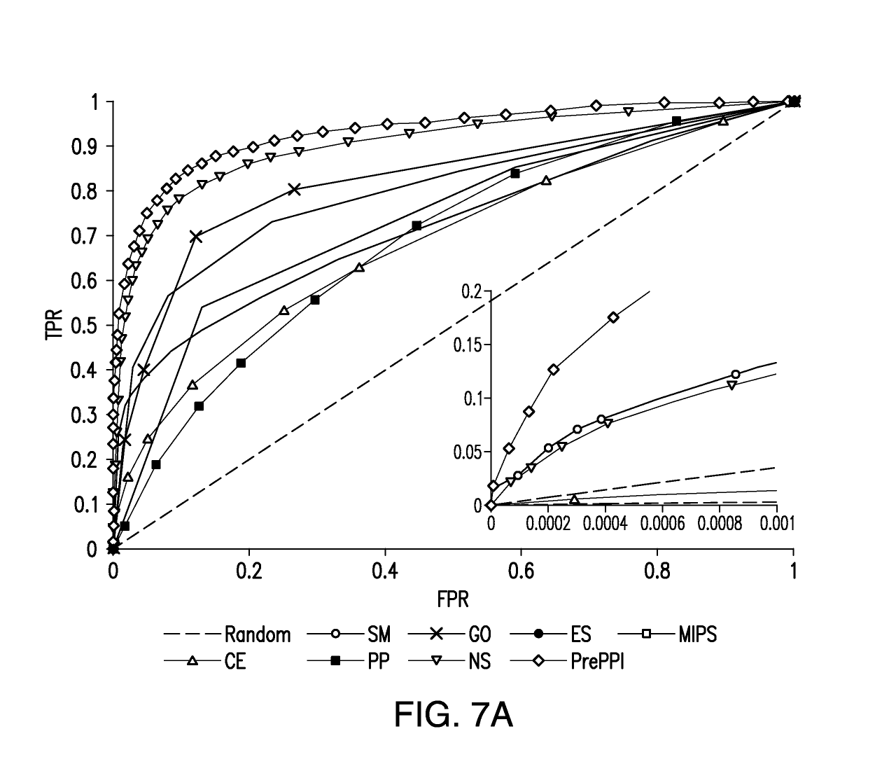

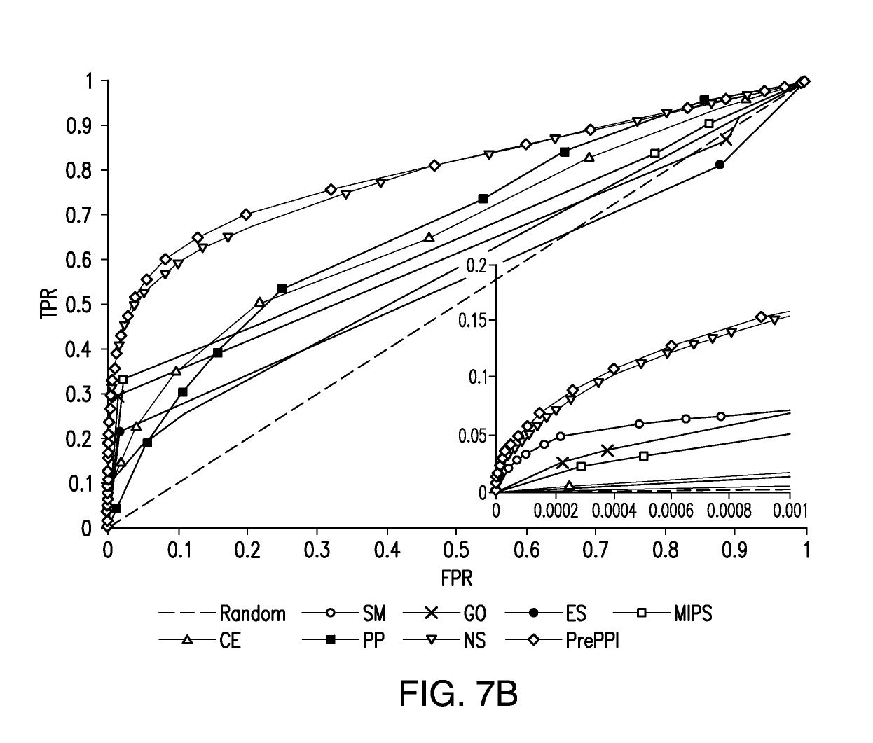

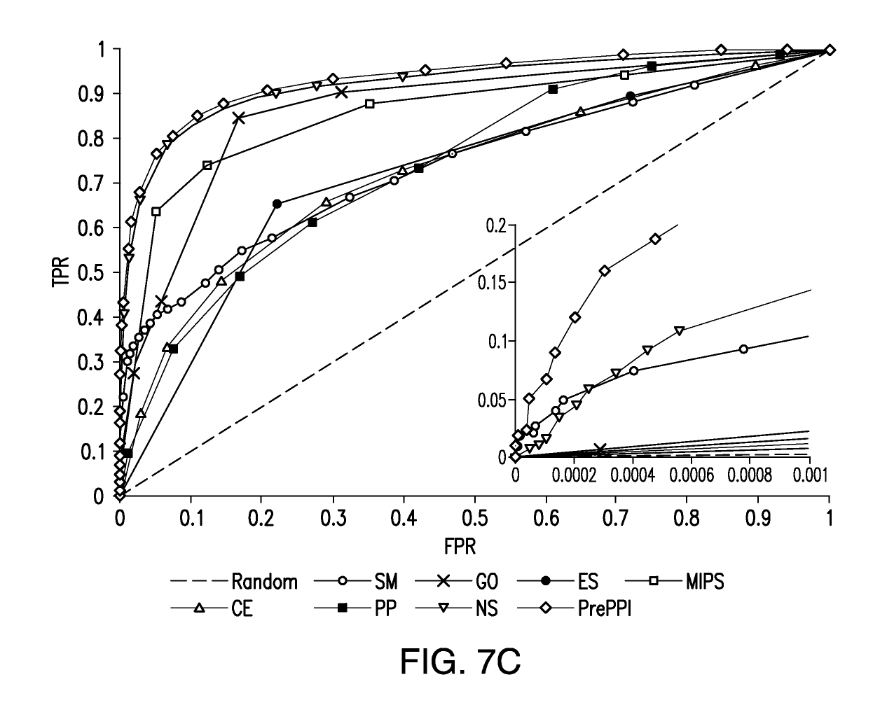

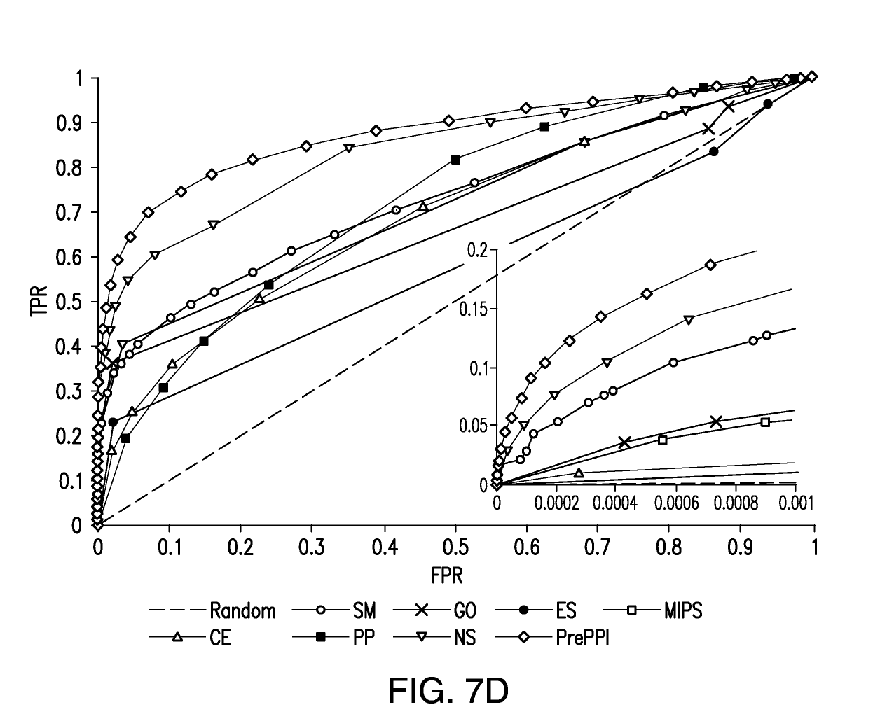

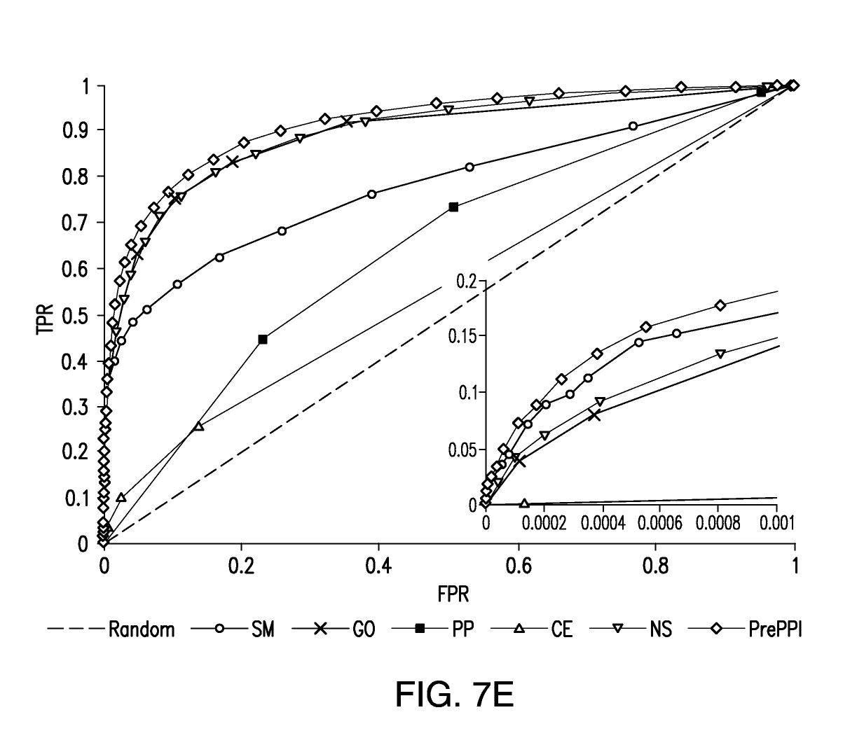

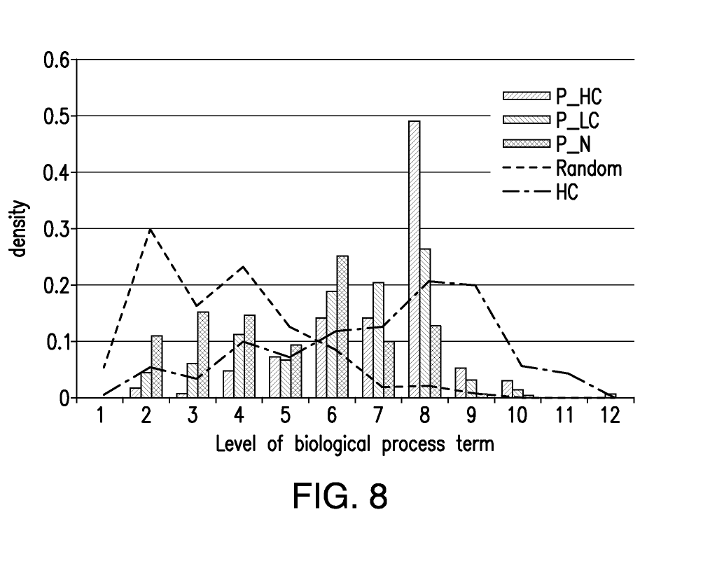

As shown in FIGS. 6 and 7, SM yields comparable performance to other clues over the entire range of false positive rate (FPR) values but is considerably more effective at low FPRs (for example, FPR≦50.1%). This is important as, owing to the huge number of negative interactions, only very low FPR rates can produce a small enough number of false positives to be used effectively in practice. In addition, the algorithm that combines structural modeling with other sources of evidence (PrePPI) shows superior performance to any method based on individual clues over the entire range of false positive rates. At low FPRs, SM by itself outperforms even the naive Bayesian classifiers that combine all non-structure-based clues (NS). Looking specifically at the thousands of high-confidence SM predictions in the LC and the N sets with an LR score >600 (a value used in reference [25] and corresponds to a FPR of ˜0.1%; see Methods), about 70% and 50%, respectively, share GO biological terms at, or more specific than, the sixth level of the GO hierarchy, suggesting that many of these interactions are real (FIG. 8).

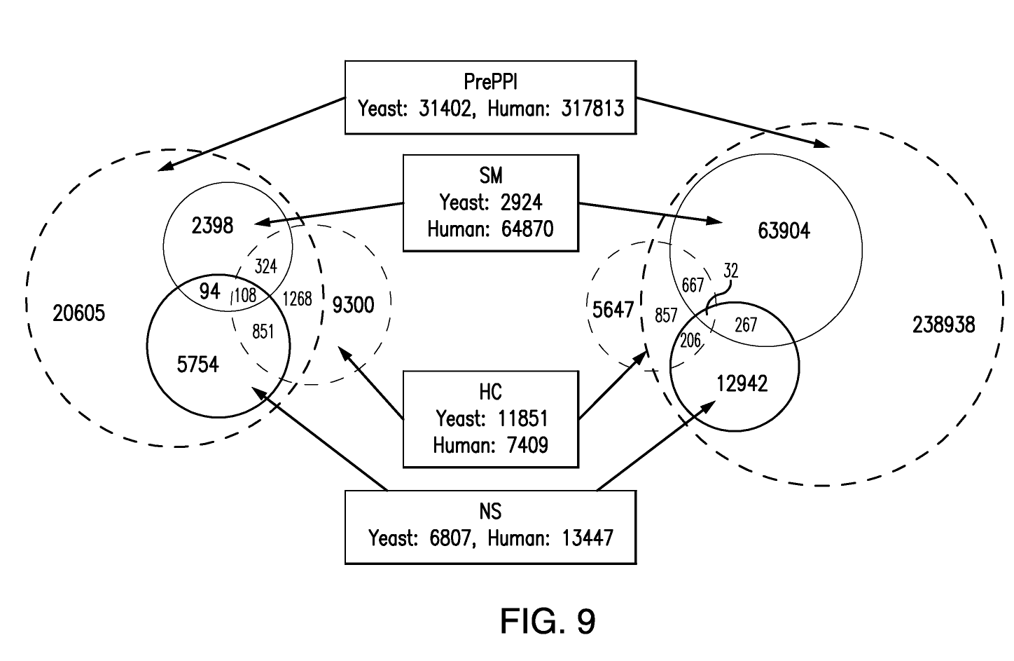

PrePPI combines structural and non-structural clues using a naive Bayesian network²⁴⁻²⁶. As shown in FIG. 7, the performance of PrePPI is superior to that obtained from structural and non-structural evidence alone, implying that the two sources of information are largely complementary. This point can be clearly seen in the Venn diagrams of high-confidence (LR>600) predictions shown in FIG. 9. In both cases, combining SM and NS into a PrePPI score offers a dramatic increase in the total number of predictions and in the coverage of the HC data set. It is evident from the figure that combining structural and non-structural clues yields many more high-confidence predictions and identifies more interactions in the HC set than either source of information alone. As an independent test of PrePPI, its performance was assessed against one of the challenges in the 2009 Dialogue for Reverse Engineering Assessments and Methods (DREAM) workshop specifically aimed at PPI prediction⁶⁷. As shown in Table 3, PrePPI outperformed all other methods for cases where structural information is available.

TABLE 3
Predicting interactions in the DREAM exercise.

| | Precision at n-th | | | | |
|---|---|---|---|---|---|
| | correct prediction | | | | |
| Prediction | 1st | 2nd | 5th | AUPR | AUROC |
| SM | 1.00 | 0.67 | 0.71 | 0.49 | 0.74 |
| PrePPI | 0.50 | 0.67 | 0.71 | 0.49 | 0.77 |
| Team1 | 1.00 | 1.00 | 1.00 | 0.70 | 0.82 |
| Team1* | 0.50 | 0.67 | 0.83 | 0.32 | 0.49 |
| Team2 | 0.20 | 0.20 | 0.12 | 0.15 | 0.48 |
| Team3 | 0.25 | 0.15 | 0.16 | 0.16 | 0.51 |
| Team4 | 0.50 | 0.67 | 0.14 | 0.18 | 0.49 |
| Team5 | 1.00 | 0.67 | 0.50 | 0.33 | 0.66 |

DREAM evaluates computational reverse engineering methods in Systems Biology, using double blind assessments based on experimentally assessed data, similar to CASP. In DREAM⁶⁸, participants were asked to predict interactions among a set of 47 proteins; 48 true interactions among these proteins had been confirmed by the DREAM organizers in at least three independent Y2H experiments by the Vidal lab. The DREAM2 evaluation program was used to benchmark all predictions. Here “precision at n-th correct prediction” is the precision calculated when a predictor correctly predicts the n-th PPI by ranking its predictions from the highest probability to the lowest. AUPR and AUROC is the area under the PR (precision-recall) curve and ROC (receiver operating characteristic) curve.

For this DREAM2 exercise, structural modeling (SM) generated models for 199 interactions between 28 proteins. Here SM predictions and the prediction that integrates both structural and non-structural clues (PrePPI) were compared with all DREAM2 participants in this subset of 199 interactions for the 28 proteins. The most up-to-date information was used in the analysis (93 true positives according to current PPI databases) and reevaluate the performance of each team based on this gold standard. As shown in Table 3, SM and PrePPI both perform much better than the other methods, except for Team1. However, the performance of Team1 seems to have been due to the fact that 19 of the true positive interactions between the target proteins were known in PPI databases at the time, and these interactions were submitted by Team1⁶⁸ as “predictions” with very high probability, i.e., based only on the fact that they were present in the databases as opposed to an independent computational technique (see Table 3). The performance of Team1 when these interactions are removed from their predictions is significantly lower (Team1*; Table 3).

The performance of PrePPI was then compared to that of high-throughput experiments (Table 4) using data provided in a detailed comparison of different high-throughout techniques reported previously⁶⁹. The data sets in reference [69] were used to define true positives, and a new negative reference set was compiled that consists of protein pairs in which each protein is annotated as localized to a different cellular compartment (see FIG. 10 and Experimental Methods). This was essential for comparison to experimental assays because, as constructed, the N set excludes data compiled from high-throughput experiments, and hence the FPR for experimental assays is artificially zero (see also related discussion in supplementary information in reference [69].

TABLE 4
High-throughput (HT) experiments.

| | | | | Source | |
|---|---|---|---|---|---|
| Dataset | | #interactions | Type | database | Reference |
| Yeast | Uetz | 1437 | Y2H | IntAct | [70] |
| | Ito | 4447 | Y2H | IntAct | [71] |
| | Yu | 1626 | Y2H | IntAct | [72] |
| | Ho | 3614 | AP/MS | IntAct | [73] |
| | Gavin02 | 3756 | AP/MS | IntAct | [74] |
| | Krogan | 8183 | AP/MS | MINT | [75] |
| | Gavin06 | 21242 | AP/MS | IntAct | [76] |
| | Tarassov | 2762 | PCA | MINT | [77] |
| Human | Rual | 2455 | Y2H | IntAct | [78] |
| | Stelzl | 2972 | Y2H | IntAct | [79] |
| | Ewing | 5504 | AP/MS | IntAct | [80] |

Abbreviations: Y2H, yeast two hybrid; AP/MS, affinity purification followed by mass spectroscopy; PCA, protein fragment complementation assay. Eight HT experiment datasets were retrieved for yeast and three for human from the IntAct⁸¹ and the MINT databases⁸². Database entries without valid UniProt⁸³ protein accession number or not defined in the yeast and the human proteomes are removed (i.e., limited to the 6,521 proteins for yeast and the 20,318 proteins for human).

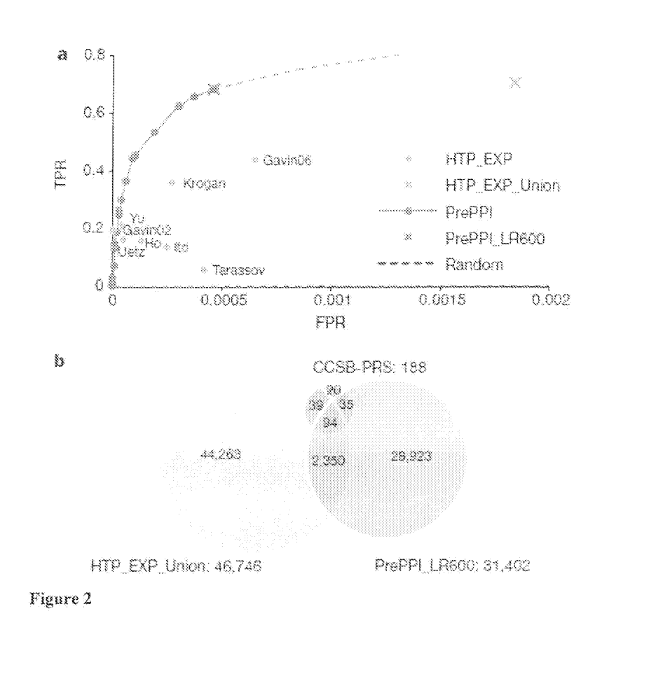

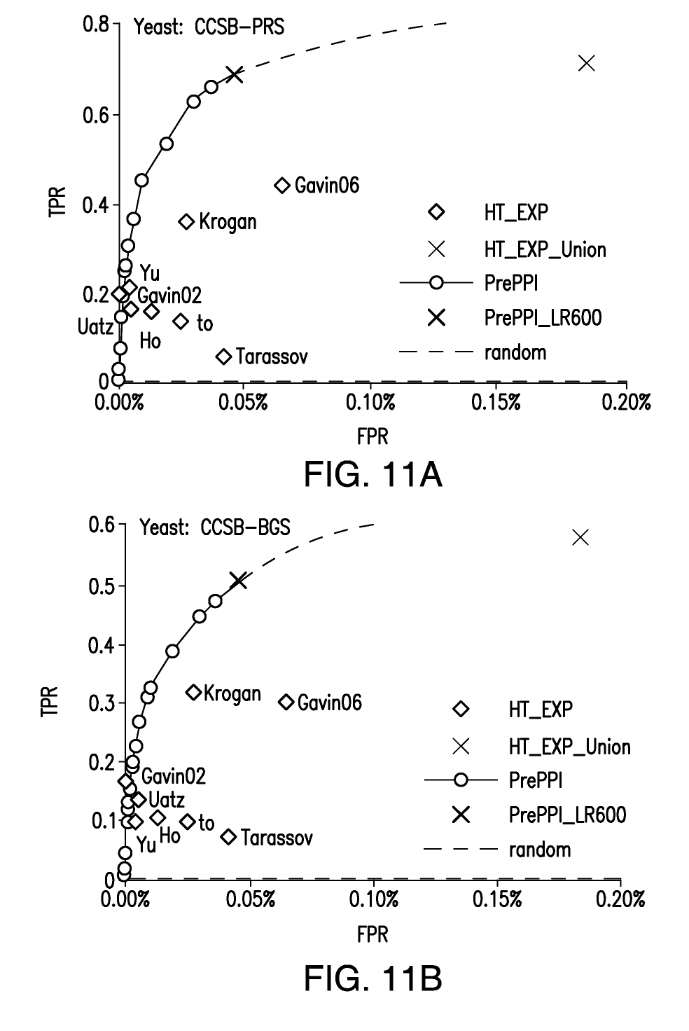

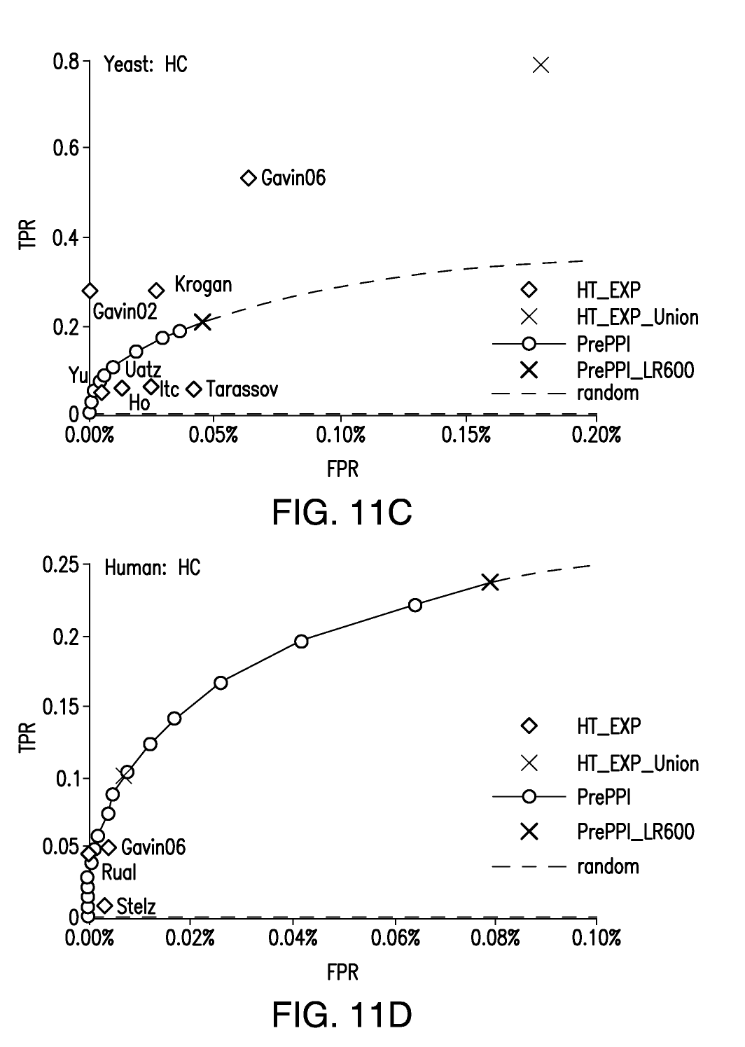

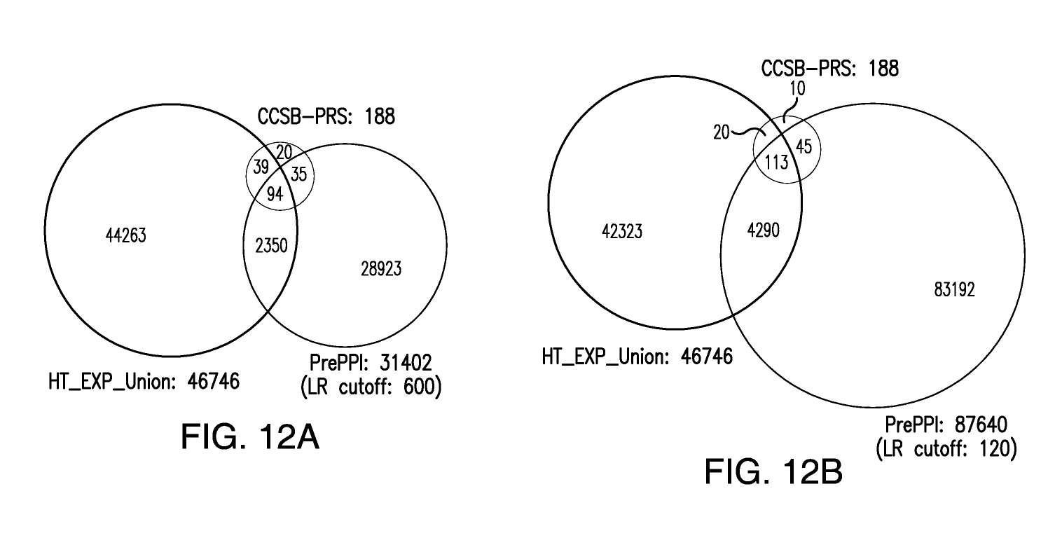

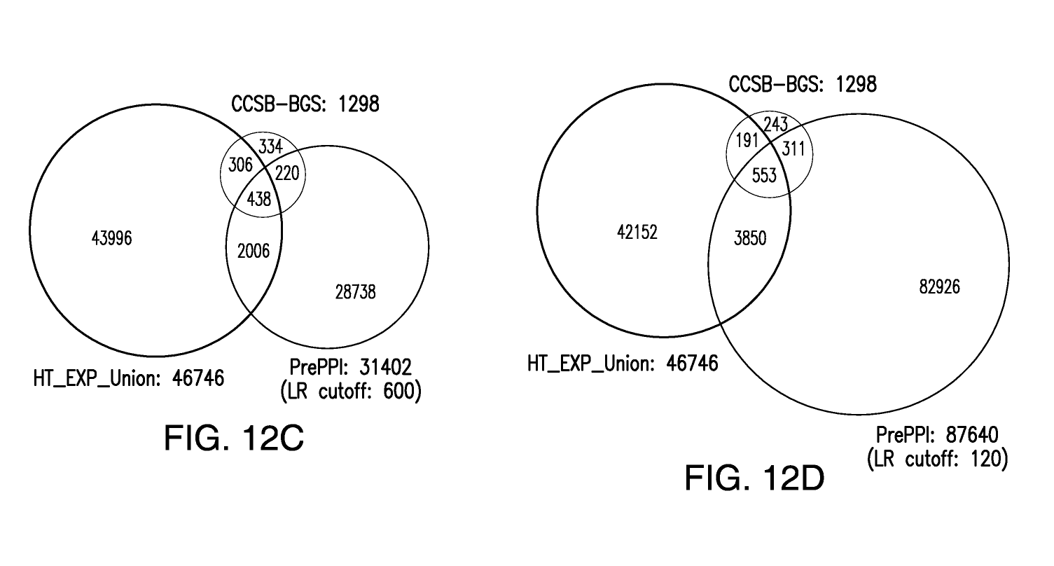

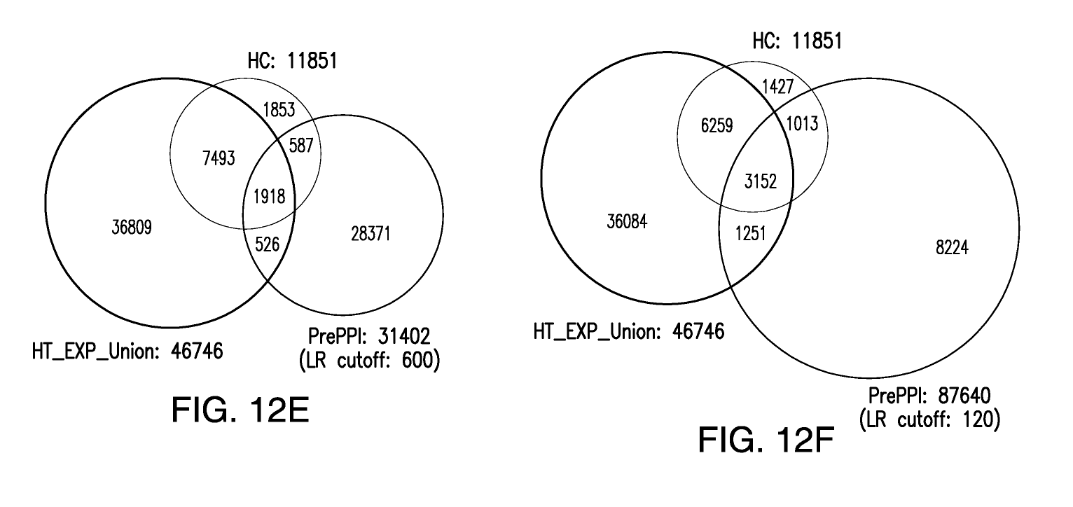

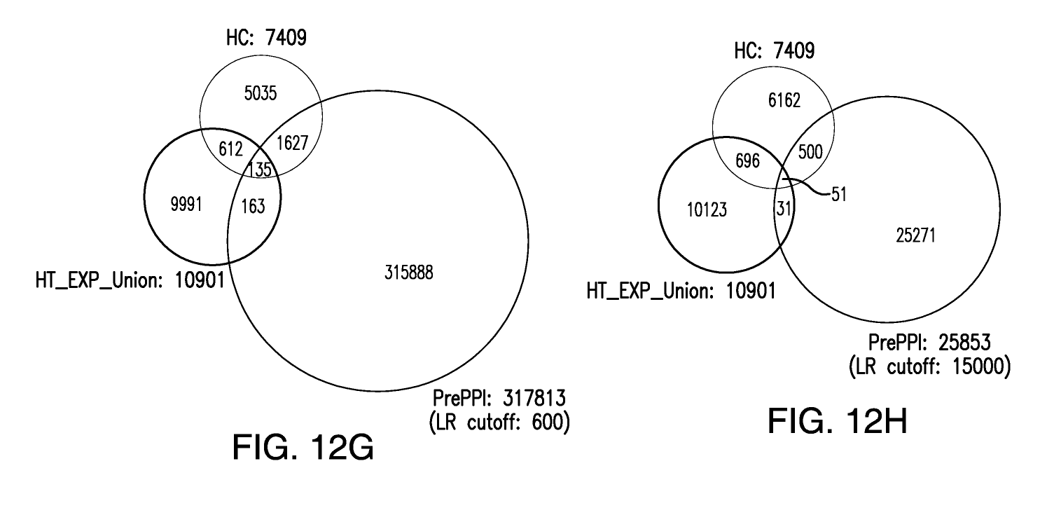

As can be seen in the receiver operating characteristic (ROC) curves reported in FIG. 2 and FIG. 11, PrePPI performance is generally comparable, and better overall, than high-throughput (HT) methods for most data sets that were tested. FIG. 2 shows a Venn diagram in which the PrePPI data set is based on an LR cutoff of 600 (FPR≦0.1%). As can be seen, many of the interactions inferred by PrePPI are different from those identified by high-throughput assays. Methods that combine both approaches can thus prove to be highly effective in expanding the coverage of PPIs. Results for other LRs and additional reference sets are shown in FIG. 12. As can be seen in FIG. 12, PrePPI consistently predicts many interactions that are in the reference sets but not identified in any HT study. These interactions were defined as the exclusive contribution of PrePPI to the reference sets (similarly, the exclusive contribution of the union of HT experiments defined to the reference sets). For most cases, the number of exclusive contributions of PrePPI is comparable to that of the union of HT experiments. The only exception is in the exclusive contributions to the yeast HC set. However, in this case the discrepancy is largely due to the fact that the yeast HC set mainly consists of interactions from HT studies (about 80% of the HC interactions are identified in at least one HT experiment). This of course biases the HC set so as to favor the evaluation of HT experiments.

PrePPI predicts 31,402 high-confidence interactions for yeast and 317,813 interactions for human at an LR cutoff of 600. These, as well as predictions with lower LR scores, are available in a database from the PrePPI website (http://bhapp.c2b2.columbia.edu/PrePPI/). As a further validation of PrePPI, its performance was tested on the approximately 24,000 new interactions involving human proteins that were added to public databases after August 2010 (Table 5). Among these interactions, 1,644 are predicted by PrePPI to have an LR>600 (based on a Bayesian classifier derived from pre-2009 data on yeast), so that they essentially correspond to experimental validation of true predictions.

TABLE 5
New human protein-protein interactions in databases
from 2010 to 2011.

| | Interactions | | |
|---|---|---|---|
| Database | August 2010 | August 2011 | New |
| HPRD | 14,977 | 38,999 | 10,324 |
| DIP | 1,460 | 12,463 | 538 |
| IntAct | 27,911 | 33,447 | 4,643 |
| MINT | 12,099 | 14,066 | 2,316 |
| BioGRID | 32,071 | 40,169 | 7,397 |
| Overall | 58,772 | 82,060 | 23,779 |

### Discussion

The exploitation of homology models and of remote structural relationships implies that each new structure that is determined experimentally can be used to detect large numbers of new functional relationships, even if the protein in question is of only limited biological interest on its own. In this regard, the PrePPI approach has benefitted from structural genomics initiatives, which produced a large increase in the coverage of sequence families that did not have structural representatives⁸⁴.

PrePPI offers a viable alternative to high-throughput experiments yielding, in addition to a likelihood of a given interaction, a model (albeit a crude one) of the domains and residues that form the relevant protein-protein interface. This in turn facilitates the generation of experimentally testable hypotheses as to the presence of a true physical interaction. These results illustrate the ability to add a structural “face” for a large number of PPIs, and that structural biology can have an important role in molecular systems biology.

Several key elements are responsible for the success of structural modeling and PrePPI. One element is the marked expansion in the number of interactions that can be modeled, owing to the use of both homology models and remote structural relationships. About 8,600 PDB structures but more than 31,000 models are found as representatives of at least one domain of ˜14,100 human proteins. If only experimentally determined structures were used in this analysis, a total of only ˜2.5 million human PPIs (versus 36 million when homology models are used) could have been modeled. Similarly, if the structural neighbors taken were limited to those in the same SCOP (Structural Classification of Proteins) fold, only ˜225 thousand interactions could have been modeled, as opposed to 36 million.

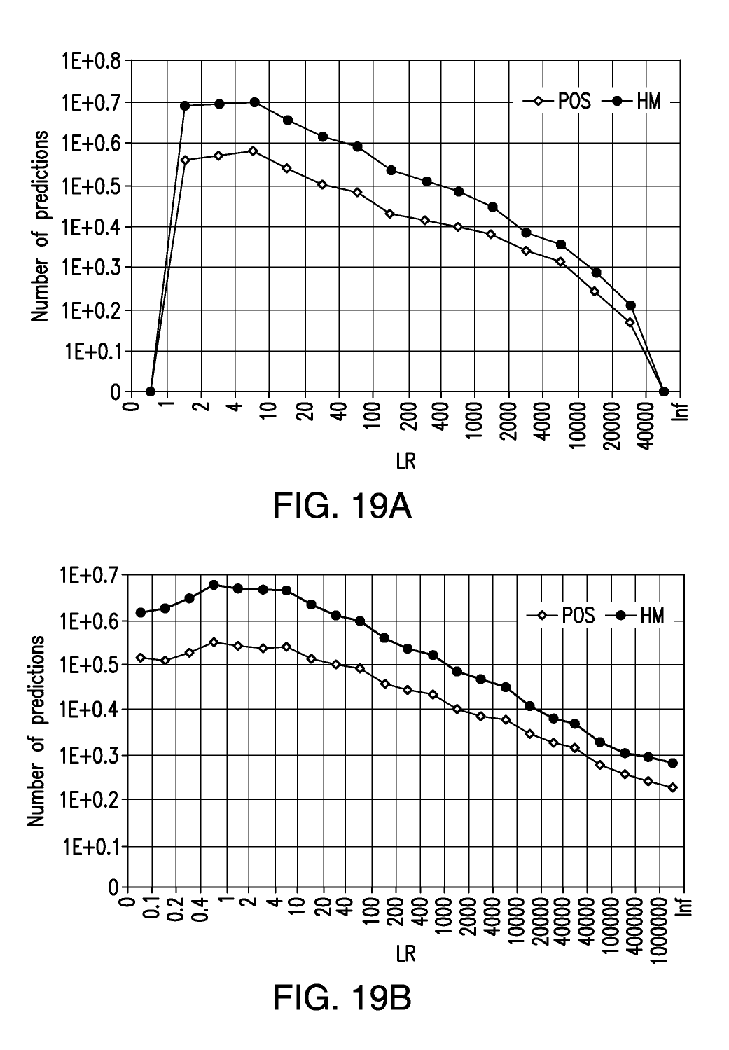

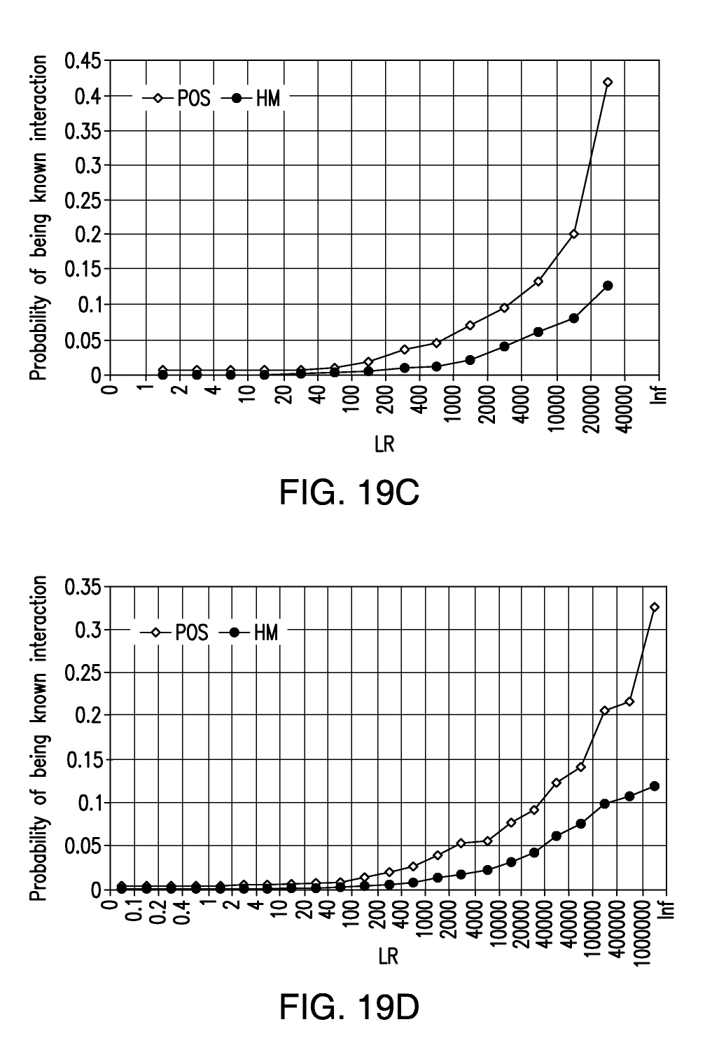

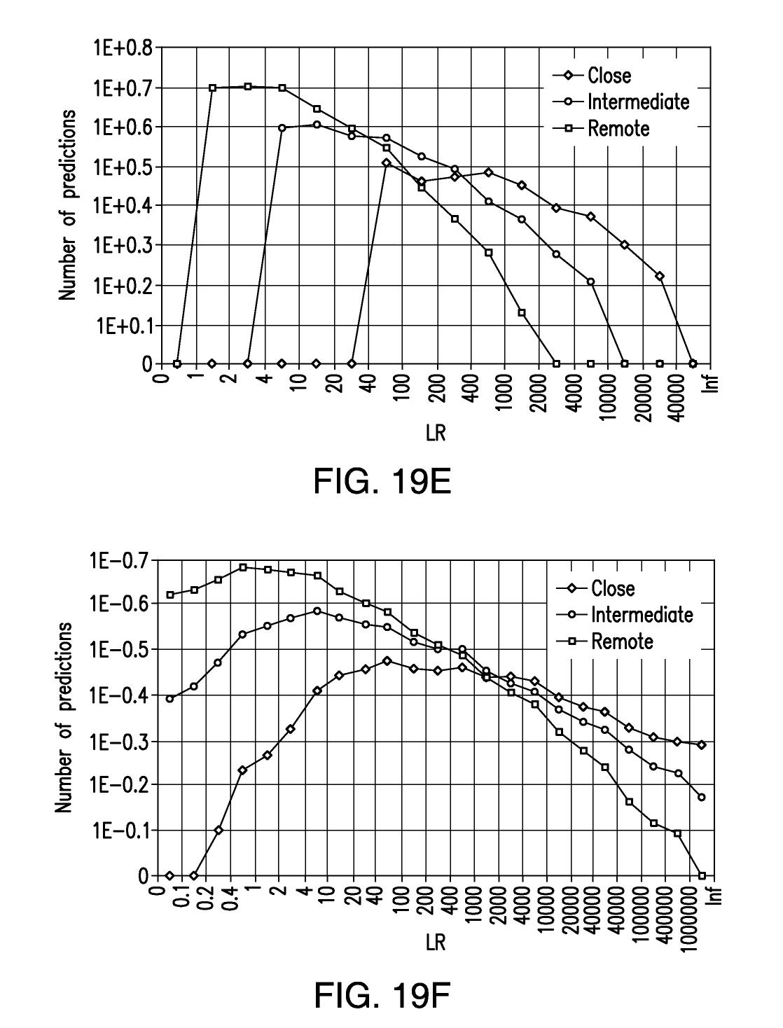

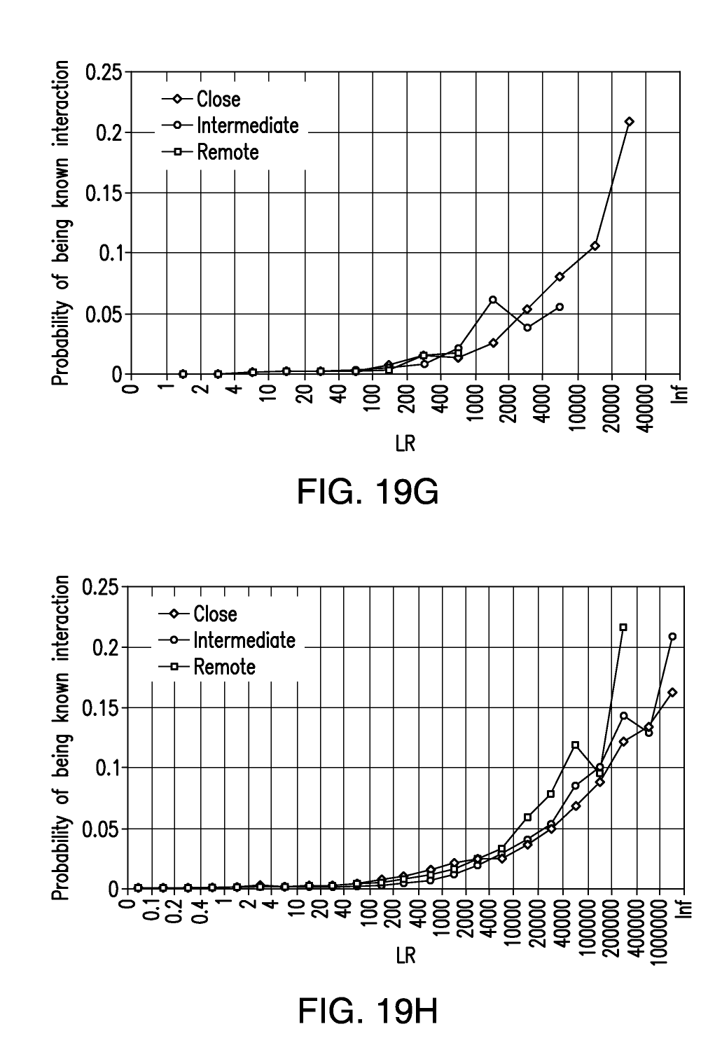

Predictions based on structural modeling that use only PDB structures or close structural neighbors are more likely to recover known interactions (defined by their presence in databases) than those that only use homology models or remote structural relationships (FIG. 19). However, the latter, on their own, yield a marked expansion in the total number of interaction models and, consequently, many more high-confidence predictions and known interactions. Most importantly, in the calculation of the PrePPI score, the huge number of low-confidence structural interaction models led to an even greater expansion in high-confidence predictions when combined with functional, evolutionary and other sources of evidence (FIG. 19).

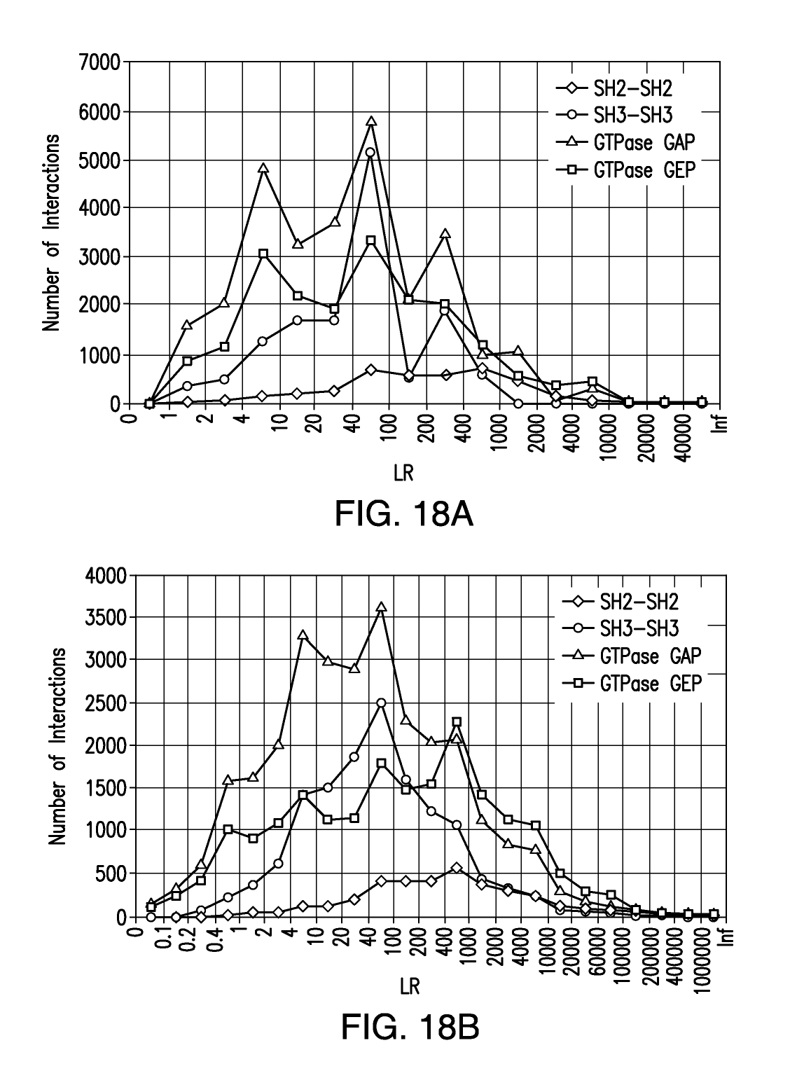

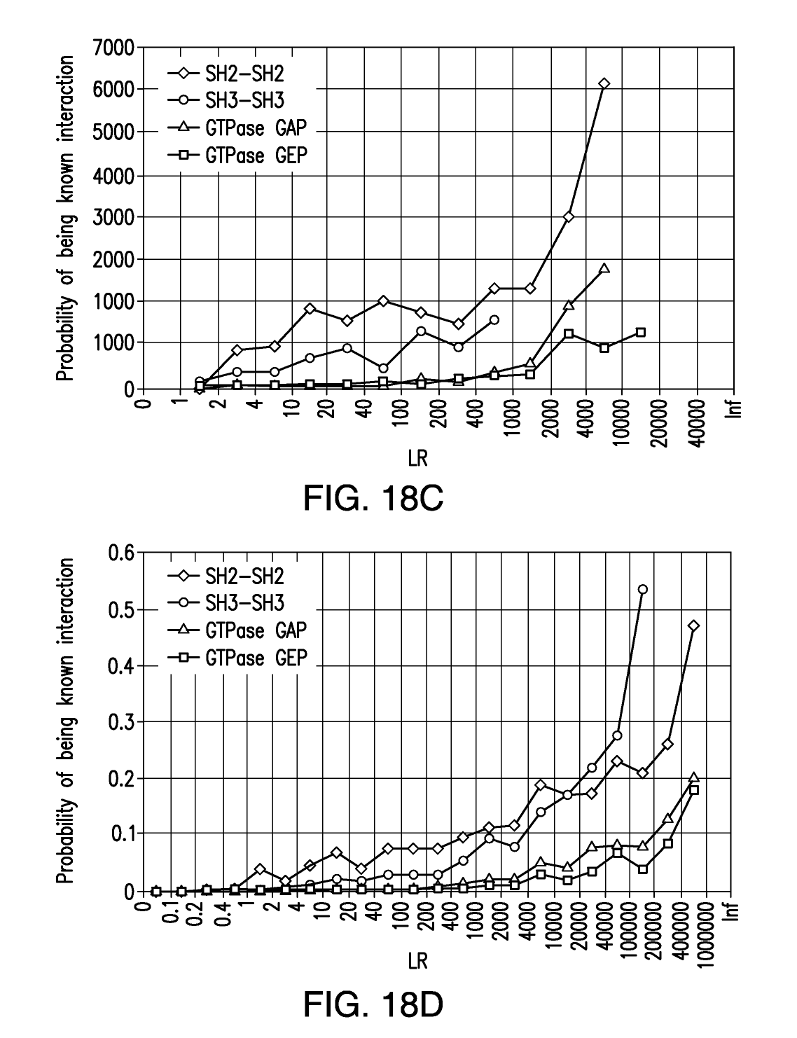

An additional element in the PrePPI strategy is the efficiency of the scoring scheme for interaction models, which allows evaluation of an extremely large number of models while still discriminating among closely related family members. Discrimination among complexes involving members of the same protein family-that is, specificity-is obtained from the properties of the predicted interface, for example, the statistical propensity of certain amino acids to appear in interfaces^{85,86} (and, additionally, from non-structural clues; for example, are the two proteins co-expressed). As examples, the analysis of the SH2 and GTPase families shows that the structural modeling (and PrePPI scores) for these closely related proteins produce a wide range of LRs, with the higher LRs associated with a higher probability of being a known interaction (FIG. 18).

Another element responsible for the success of PrePPI is the Bayesian evidence integration method that allows independent and any weak interaction clues to be combined to make reliable predictions and to improve prediction specificity (FIGS. 18 and 19).

### Example 2

### Experimental Validation of the PREPPI-Predicted Protein-Protein Interactions

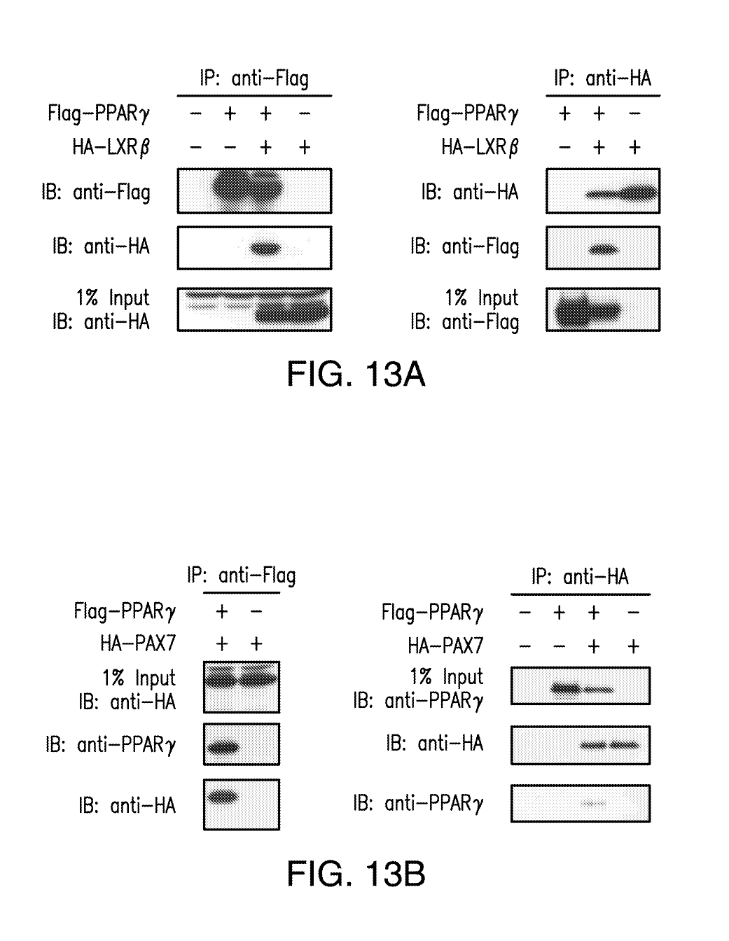

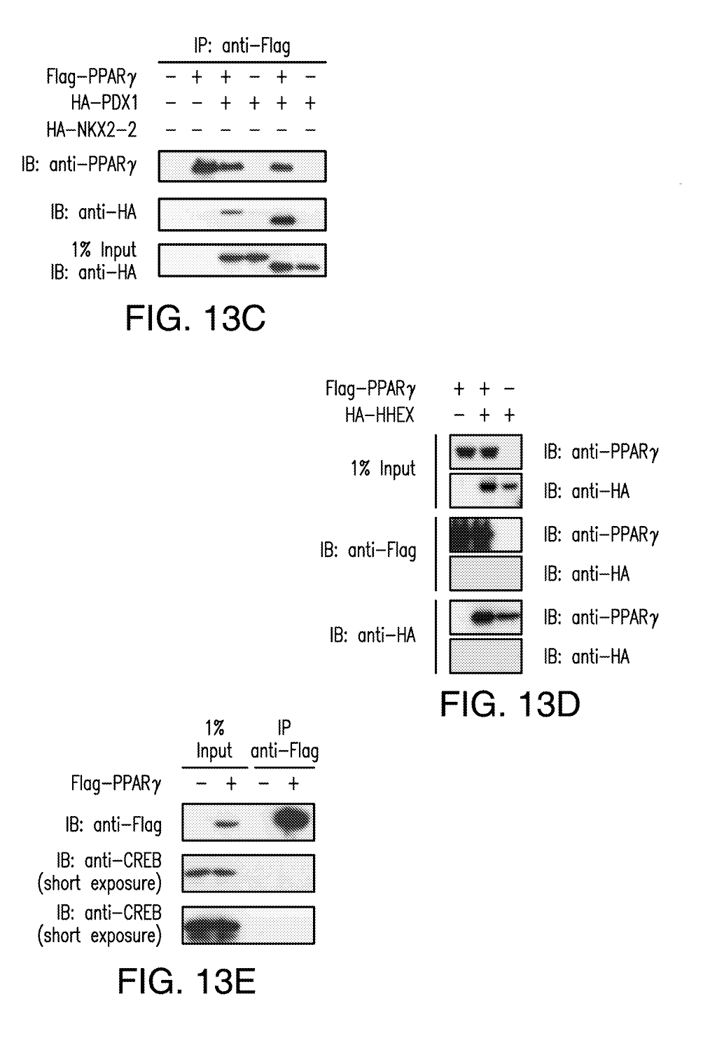

Specific experimental validation of 19 individual PrePPI predictions, using co-immunoprecipitation (Co-IP) assays, was carried out in four separate laboratories, leading to confirmation of 15 of these interactions (FIGS. 13-17 and Table 6). Specifically, the investigators in each laboratory queried the PrePPI database for previously uncharacterized interactions involving proteins of interest and that had relatively high SM and PrePPI scores (see Table 6 for more information).

Experimental tests of a number of predictions demonstrate the ability of the PrePPI algorithm to identify unexpected PPIs of considerable biological interest. The effectiveness of three-dimensional structural information can be attributed to the use of homology models combined with the exploitation of both close and remote geometric relationships between proteins.

### Methods

### Co-Immunoprecipitation in Mammalian Cells

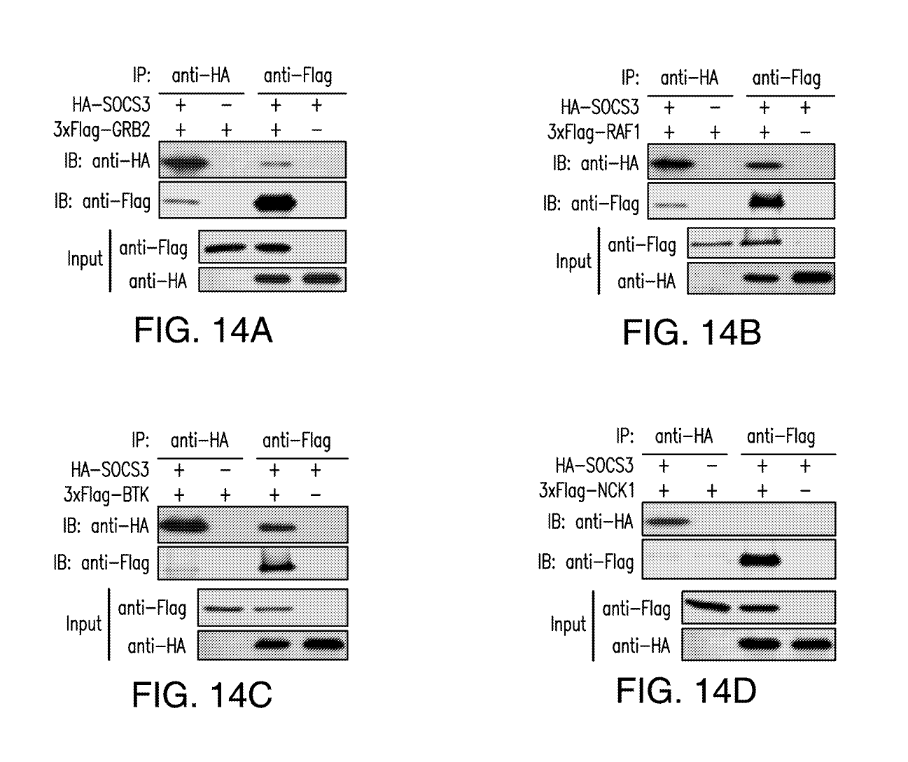

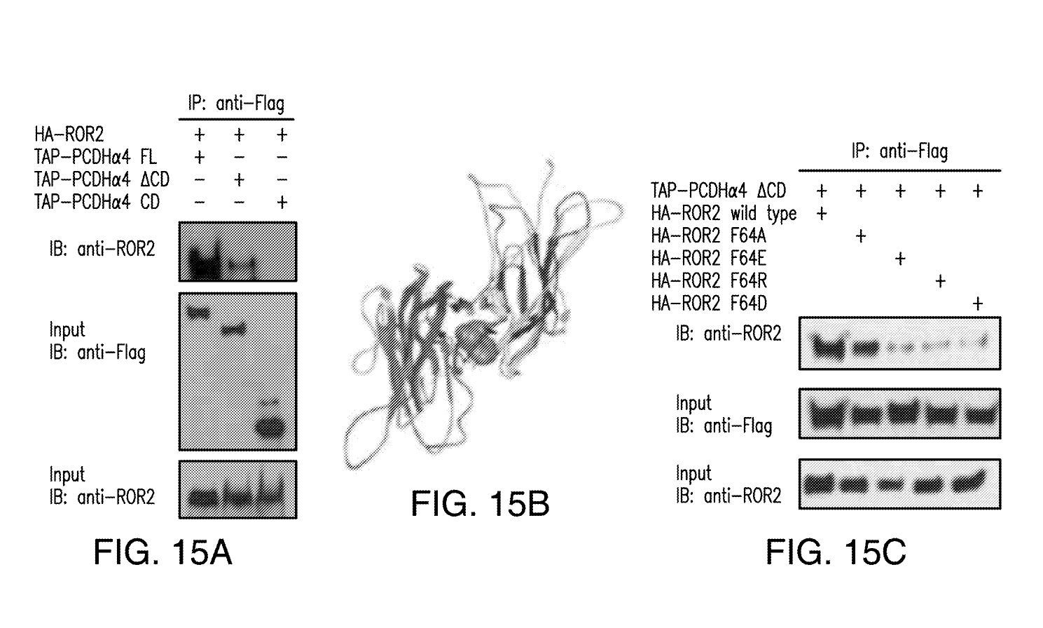

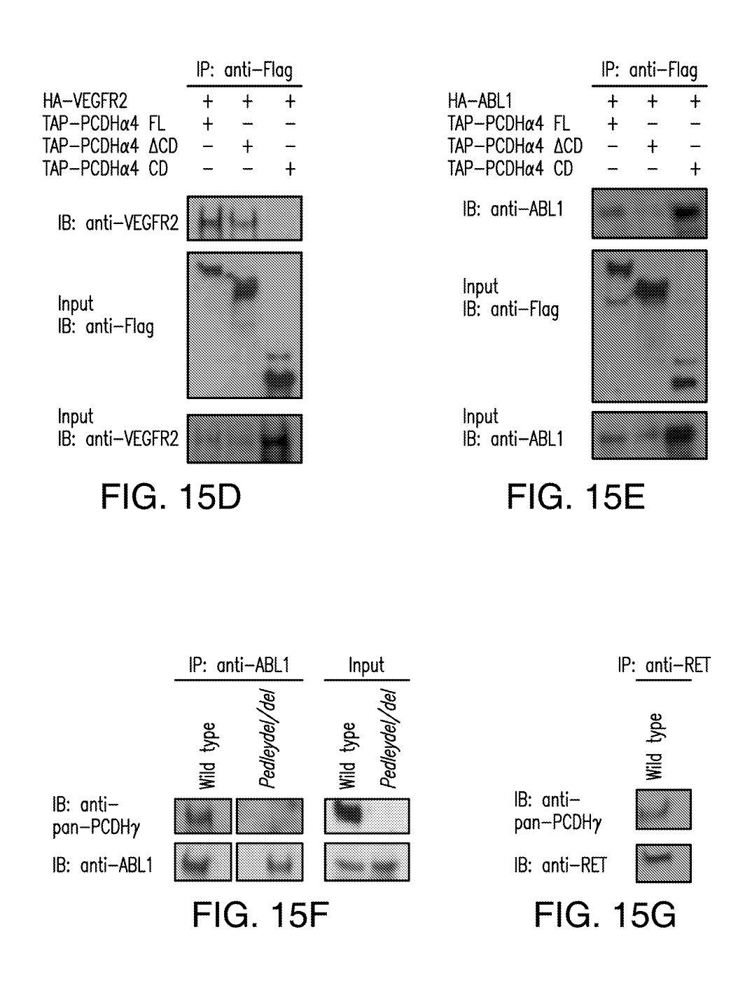

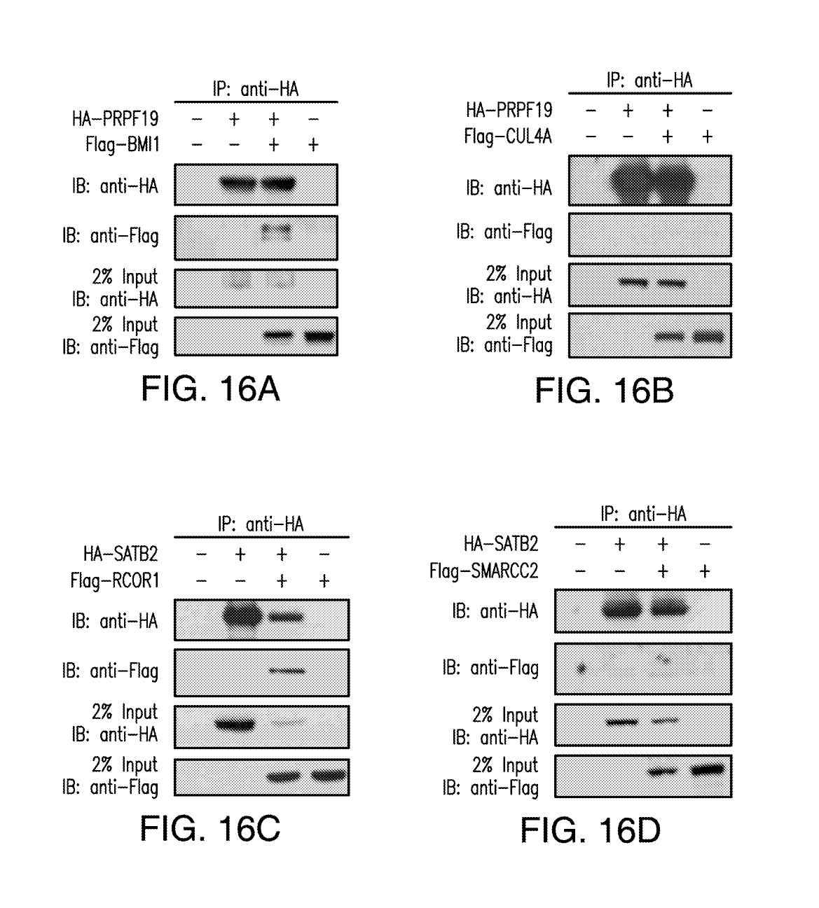

Forty-eight hours after transfection with indicated expression plasmids, HEK-293T cells were lysed in lysis buffer (20 mM HEPES pH 7.9, 100 mM NaCl, 0.2 mM EDTA, 1.5 mM MgCl₂, 10 mM KCl, 20% glycerol and 0.1% Triton-X100 for FIGS. 13 and 14; 20 mM Tris-HCl, pH 7.5, 150 mM NaCl, 1 mM EDTA and 1% NP-40 for FIGS. 15; and 1×Cell Lysis Buffer (Cell Signaling) for FIG. 16 supplemented with Protease Inhibitor Cocktail (Roche). Cell lysates were sonicated and pre-cleared with 30 μl of Protein G Sepharose (GE) before incubating with 15 μl anti-Flag M2 or 40 μl anti-HA Affinity Gel (Sigma-Aldrich) overnight at 4° C. with shaking. Agarose beads were washed four times with lysis buffer. Lysates (input) and immunoprecipitates were denatured in reducing protein sample buffer, analysed by SDS-PAGE and immunoblotted with anti-Flag (Sigma-Aldrich), anti-HA (Roche), anti-PPAR-γ (Santa Cruz), anti-ABL1 (Santa Cruz), anti-ROR2 (Cell Signaling) or anti-VEGFR2 (Abcam) antibodies as indicated.

Protein Analysis from Brain

Crude membrane fractions were prepared from brains of postnatal day (P)0 to P5 wild-type mice or Pcdhg^{del/del} mice provided by X. Wang. The brain tissues were homogenized in a buffer A, consisting of 5 mM Tris-HCl, pH 7.4, 0.32 M sucrose, 1 mM EDTA, 50 mM dithiothreitol supplemented with the Complete Protease Inhibitor Cocktail. The nuclei and insoluble debris were collected by a low-speed centrifugation at 1,000 g for 10 min and subsequently the supernatant was collected by centrifugation at 22,000 g for 30 min. The pellet was washed in the buffer A and solubilized in lysis buffer (Pierce). Crude membrane fraction (supernatant) was collected by centrifugation at 22,000 g for 20 min.

### Selection of PrePPI Predictions to Analyze

Four different set of experiments were performed to test the accuracy of the PrePPI database. The PrePPI website (http://bhapp.c2b2.columbia.edu/PrePPI/) was searched for biologically interesting and surprising predictions involving proteins of interest and to the extent feasible based on relatively high PrePPI and Structural Modeling (SM) scores.

Specifically, for the six PPAR-γ experiments (Table 6), transcription factors that were potential interaction partners were focused on. First, the nuclear receptor LXRβ, which is predicted to interact with PPAR-γ with the highest prediction LR, was selected and then skipped a group of other nuclear receptors that also had a high LR but were similar to LXRβ. Then transcription factors other than nuclear receptors among the high LR predictions and selected four proteins (PAX7, PDX1, HHEX, and NKX2-2) were selected to test. There are a few other transcription factors, for example HOXA7 and HOXA5, that were not nuclear receptors and have PrePPI scores higher than the ones chosen but these were not tested because their structural modeling scores are very low and the prediction was based on non-structural information. Finally, CREB was selected as a negative control since it has no structural clue for an interaction with PPARγ and has a relatively low PrePPI score. In addition, the predicted interaction between VHL and EEF1D were also validated, for which there was only evidence from a single high-throughput study.

For the four SOCS3 experiments (Table 6), predicted interaction partners with the highest LRs that are known components of the cytokine receptor signaling pathway were searched for. In particular, targets that are in the Ras/MAP kinase pathway were focused on. There are many other proteins predicted to interact with SOCS3, some of them with higher PrePPI LR scores, but these were not tested because they are not part of this pathway.

For the four protocadherin experiments (Table 6), potential kinase interaction partners with protocadherin that had PrePPI LRs higher than 100 were identified. RET, ROR2, VEGFR2, and ABL were chosen based on their having both high LR scores and high SM scores.

For the experiments aimed to identify new components of large protein-protein complexes (Table 6), it was required that a protein is predicted to interact with multiple components of a known complex, but that the protein itself is not a known component of this complex. Another requirement was that the protein and the complex have different general functions. With these and the criteria of high PrePPI and SM LR scores, PRPF19 was predicted to interact with two components (CUL4A and BMI1) of the centromere chromatin complex and SATB2 is predicted to interact with two components (SMARCC2 and RCOR1) of the Emerin “proteome” complex 32.

### Results

Nineteen PrePPI predictions of human interactions using Co-IP experiments were tested. Fifteen of the predictions were confirmed experimentally, which are summarized in the following Table 6 along with PrePPI prediction scores. Protein plasmid information and domain information are provided in Table 6 (B) and (C). Most experiments were carried out by transfecting HEK293 cells with plasmids expressing Flag- and HA-tagged proteins, which are then pulled down and probed with Flag or HA antibodies (FIGS. 13-17). Some experiments used endogenous proteins or in vivo systems.

One set of predictions involved potential PPIs formed between the nuclear receptor peroxisome proliferator-activated receptor γ (PPAR-γ) and other transcription factors. PPAR-γ plays a pivotal role in regulating glucose and lipid metabolism, the inflammatory response and tumorigenesis, and is known to heterodimerize with retinoid X receptors (RXRs) and to recruit cofactors to regulate target gene transcription⁸⁷. PrePPI predicts high-confidence interactions between PPAR-γ and the transcription factors LXR-β (also known as NR1H2), PAX7, PDX1, NKX2-2 and HHEX (Table 6). Except for HHEX, all of the interactions were validated (FIG. 13). The predicted interaction with nuclear receptor LXR-β can be expected based on the ability of these proteins to heterodimerize through their ligand-binding domains. Nevertheless, this specific interaction had not previously been characterized and indicates a thus far unrecognized convergence of signaling and metabolic pathways regulated by these two nuclear receptors. The interaction between the ligand-binding domain of PPAR-γ and the homeodomains of PAX7, PDX1 and NKX2-2 are new observations that require further studies, as they indicate that PPAR-γ can have a role in endocrine progenitor and pancreatic β-cell development, which can be direct.

A second set of examples involved suppressor of cytokine signaling (SOCS3), an SH2-domain-containing protein, that is induced by many cytokines and growth factors negatively regulates cytokine-induced signal transduction⁸⁸. To date, the mechanism of the inhibitory function of SOCS3 has been primarily established for its involvement in the JAK/STAT pathway⁸⁹. Using the methods described herein, PrePPI predicts that SOCS3 forms complexes with GRB2 and RAF1, two key components in the RAS/MAPK pathway, and these interactions were confirmed experimentally (FIG. 14A, B). Using the methods described herein, PrePPI also predicts the formation of a complex between SOCS3 and BTK, a cytoplasmic tyrosine kinase important in B-lymphocyte development, differentiation and signaling, and this interaction was also validated (FIG. 14C). These results indicate that SOCS3 can play a broader role in cytokine-induced signaling and in particular the RAS/MAPK pathway. The SOCS3-GRB2 interaction is predicted to be mediated by their SH2 domains, whereas the SOCS3 interaction with BTK is predicted to be mediated by an SH2-SH3 domain interaction. Analysis of the predicted binding preferences of SH2 domains as well as results on other protein families indicate that the PrePPI scoring function accounts, at least in part, for the binding preference of closely related protein domains (FIG. 18).

A third group of observations involves the identification of kinases that interact with the clustered protocadherin proteins (protocadherin α, β and γ (PCDH-α, -β and -γ)). Protocadherins are the largest subgroup of the cadherin superfamily of cell surface proteins. The PCDHs have six cadherin-like extracellular domains, and unique cytoplasmic domains. They assemble into large complexes at the cell surface, and associate with a variety of proteins, including signalling adaptors, kinases and phosphatases, and are highly expressed in the nervous system and genetic studies in mice have suggested that mammalian clustered protocadherin genes can play important roles in regulating neuronal survival and synaptic connectivity in the central nervous system⁹⁰⁻⁹². Analysis of potential PCDH-kinase PPIs confirmed published interactions between PCDH-α and -γ with the tyrosine kinase RET⁹³, and predicted interactions with ROR2, VEGFR2 and ABL1 (Table 6 and FIG. 15; experiments done in mice). PrePPI predicted that these PPIs are mediated by the extracellular cadherin domains and immunoglobulin (Ig) domains, a result that was confirmed experimentally (FIG. 15A-D). A hydrophobic residue, Phe 64, of the ROR2 Ig domain is predicted to be in the centre of the interface it forms with PCDH-α4. Mutating this Phe to an Ala, a smaller hydrophobic residue, has no detectable effect on binding, whereas mutating it to charged residues considerably weakens the interaction (FIG. 15B, C). These results indicate that, in addition to predicting binary interactions, PrePPI can reveal novel and unsuspected interfaces.

Recent studies have shown that ABL1 plays an important role in development of nervous system and implicated with neurodegenerative diseases⁹⁴⁻⁹⁶. The validation of protocadherin interaction with ABL1 indicates that follow-up experiments can provide important functional insights into role of protocadherins in the nervous system. The interaction between protocadherins and VEGFR2 also raises that protocadherins can potentially function in axon growth in developing neurons as recent evidence suggests that VEGFR2 is required for axon tract formation in mouse brain⁹⁷. Since ROR1 and ROR2 were recently reported to play a key role in Wnt 5a activated signaling and modulate synapse formation in hippocampal neurons, the interaction between protocadherins and ROR2 can also indicate a potential role of protocadherins in synapse formation⁹⁸.

TABLE 6
Co-immunoprecipitation (Co-IP) experiments.
(A) PrePPI predictions and experimental results.

| Predicted | Need homology | Sequence | Structure | Domain1-Domain2: | Domain1-Domain2: | PrePPI_LR | | |
|---|---|---|---|---|---|---|---|---|
| Interaction^{a} | model? | homology | family | (model)^{b} | (template)^{b} | (probability) | | Result^{c} |
| PPAR- | No | PFAM family | SCOP family | LBD-LBD | LBD-LBD | 3.6E6 | (>0.99) | Confirmed |
| γ [symbol] LXRβ | | (sid.<30%) | | | | | | (FIG. S10) |
| PPAR- | Yes | No | No | LBD-Homeo | LBD-LBD | 4010 | (0.87) | Confirmed |
| γ [symbol] PAX7 | | | | | | | | (FIG. S10) |
| PPAR- | Yes | No | No | LBD-Homeo | LBD-LBD | 3114 | (0.84) | Confirmed |
| γ [symbol] PDX1 | | | | | | | | (FIG. S10)^{d} |
| PPAR- | Yes | No | No | LBD-Homeo | LBD-LBD | 2764 | (0.82) | Confirmed |
| γ [symbol] NKX2-2 | | | | | | | | (FIG. S10)^{d} |
| PPAR- | Yes | No | No | LBD-Homeo | LBD-LBD | 3602 | (0.86) | Not Confirmed |
| γ [symbol] HHEX | | | | | | | | (FIG. S10)^{d} |
| PPAR- | No structural model was built | | | | | 63 | (0.10) | Not Confirmed |
| γ [symbol] CREB | | | | | | | | (FIG. S10)^{d, e} |
| VHL [symbol] EEF1D | Yes | No | No | VHL- | Ubiquitin- | 53 | (0.08) | Confirmed |
| | | | | EF1_GNE | UBC | | | (FIG. S14)^{f} |
| SOCS3 [symbol] RAF1 | Yes | No | No | SH2-RBD | Pcc1-Pcc1 | 104 | (0.15) | Confirmed |
| | | | | | | | | (FIG. S11) |
| SOCS3 [symbol] GRB2 | Yes | PFAM family | No | SH2-SH2 | SH2-SH2 | 7.6E4 | (0.99) | Confirmed |
| | | (sid.<30%) | | | | | | (FIG. S11) |
| SOCS3 [symbol] BTK | Yes | PFAM family | No | SH2-SH3 | SH2-SH3 | 4242 | (0.88) | Confirmed |
| | | (sid.<30%) | | | | | | (FIG. S11) |
| SOCS3 [symbol] NCK1 | Yes | PFAM family | No | SH2-SH2 | SH2-SH2 | 2064 | (0.77) | Not Confirmed |
| | | (sid.<30%) | | | | | | (FIG. S10) |
| PCDH- | Yes | PFAM family | SCOP | CA-CA | CA-CA | 3296 | (0.85) | Confirmed |
| α4 [symbol] RET | | (sid.<30%) | family | | | | | (FIG. S12)^{g} |
| PCDH- | Yes | No | SCOP | CA-Ig | CA-CA | 350 | (0.58) | Confirmed |
| α4 [symbol] ROR2 | | | fold | | | | | (FIG. S12)^{d, h} |
| PCDH- | Yes | No | SCOP | CA-Ig | CA-CA | 224 | (0.23) | Confirmed |
| α4 [symbol] VEGFR2 | | | fold | | | | | (FIG. S12)^{d, h} |
| PCDH- | Yes | No | No | CA-SH3 | Cap_Gly- | 147 | (0.20) | Confirmed |
| α4 [symbol] ABL1 | | | | | Cap_Gly | | | (FIG. S12)ⁱ |
| PRPF19 [symbol] CUL4A | Yes | No | SCOP | Ubox-Nedd8 | Ubox- | 7246 | (0.92) | Not Confirmed |
| | | | superfamily | | Nedd8 | | | (FIG. S13)^{j} |
| PRPF19 [symbol] BMI1 | Yes | No | SCOP | Ubox-RING | RING-RING | 1249 | (0.68) | Confirmed |
| | | | superfamily | | | | | (FIG. S13)^{j} |
| SATB2 [symbol] SMARCC2 | Yes | No | No | Homeo- | Homeo- | 2486 | (0.81) | Confirmed |
| | | | | SWIRM | Homeo | | | (FIG. S13)^{j} |
| SATB2 [symbol] RCOR1 | Yes | No | SCOP | Homeo-SANT | Homeo- | 821 | (0.58) | Confirmed |
| | | | superfamily | | Homeo | | | (FIG. S13)^{j} |

^{a}Protein and plasmid information are given in the following Table B;
^{b}Domain information is given in the following Table C;
^{c}If not indicated, both Flag-IP and HA-IP experiments are performed;
^{d}Only Flag-IP experiments are performed;
^{e}The experiment is done by probing endogenous CREB in anti-Flag IP (PPAR-γ is Flag-tagged);
^{f}The interaction has been reported in Reference [108], and is in the DIP and IntAct databases;
^{g}The interaction has been reported in Reference [93], but has not been curated in any database. The interaction of PCDHγ with RET was verified in vivo in mice by probing with anti-RET and anti-pan PCDHγ antibodies;
^{h}Experiments are done using plasmids expressing mouse proteins;
ⁱThe interaction was verified in vitro by transfecting HEK293 cells with a plasmid expressing Flag-tagged mouse PCDH-α4, the interaction of PCDHγ with ABL1 was also verified in vivo in mice by probing with anti-ABL1 and anti-pan PCDHγ antibodies. Since ABL1 is a cytoplasmic protein, it must interact with the cytoplasmic region of PCDHs. The PrePPI prediction was due in part to weak structural evidence involving the extracellular domain of PCDH, which in this case cannot be correct, and to non-structural evidence which can be responsible for the positive, though low probability prediction;
^{j}Only HA-IP experiments are performed.

The second column shows whether homology models are required for the structural modeling of the indicated interaction, and “Yes” means that at least one of the two structures is a homology model. The third column shows whether the two proteins are sequence homologues of any known interactions. The fourth column shows whether both structures of the target protein domains are in the same SCOP category as the corresponding structural neighbors in the template complex. When a homology model (of individual target protein) is used, the SCOP ID of the template structure is used upon which the homology model is built (please note here both template and homology model refer to individual protein, not the complex) as the SCOP ID of the target domain. The fifth and the sixth columns show the domains that are predicted to mediate the interaction and also the domain-domain interaction in the template structure. In the seventh column, PrePPI LR score is scaled into a probability score from 0 to 1 using the following formula. An LR cutoff of 600 was used so that the probability score of a prediction of LR score 600 will be 0.5⁶:

$$p = \frac{LR}{LR + {LR}_{cut}}$$

### (B) Protein Information and Plasmid Sources.

| Protein | | |
|---|---|---|
| name | Protein information | Source (Company: accession#) |
| PPAR-γ | Peroxisome proliferator-activated receptor gamma | Genecopoeia: U63415.1 |
| LXRβ | Oxysterols receptor LXR-beta | Genecopoeia: NM_007121.1 |
| PDX1 | Paired box protein Pax-7 | Genecopoeia: NM_013945.1 |
| PAX7 | Pancreas/duodenum homeobox protein 1 | Genecopoeia: NM_000209.1 |
| NKX2-2 | Homeobox protein Nkx-2-2 | Genecopoeia: NM_002509.1 |
| HHEX | Hematopoietically-expressed homeobox protein | Genecopoeia: L16499.1 |
| CREB | Cyclic AMP-responsive element-binding protein 1 | endogenous |
| VHL | Von Hippel-Lindau disease tumor suppressor | Genecopoeia: NM_000551.1 |
| EEF1D | Elongation factor 1-delta | Genecopoeia: NM_001960.1 |
| SOCS3 | Suppressor of cytokine signaling 3 | self-cloned: NM_003955 |
| RAF1 | RAF proto-oncogene serine/threonine-protein kinase | self-cloned: NM_002880 |
| GRB2 | Growth factor receptor-bound protein 2 | self-cloned: NM_002086 |
| BTK | Bruton tyrosine kinase | self-cloned: NM_000061 |
| NCK1 | Cytoplasmic protein NCK1 | self-cloned: NM_006153 |
| PCDH-α4 | Protocadherin alpha-4 | Full length protein and different variants (FIG. |
| | | 15) were made by Stefanie S. Schalm and |
| | | published previously⁹³. |
| RET | Proto-oncogene tyrosine-protein kinase receptor RET | endogenous |
| ROR2 | Tyrosine-protein kinase transmembrane receptor | Addgene: AB010384 |
| | ROR2 | |
| VEGFR2 | Vascular endothelial growth factor receptor 2 | Openbiosystems: BC020530 |
| ABL1 | Abelson tyrosine-protein kinase 1 | Addgene: NM_0011127032 |
| PRPF19 | Pre-mRNA-processing factor 19 | Genecopoeia: NM_014502.4 |
| CUL4A | Cullin-4A | OriGene: NM_001008895.1 |
| BMI1 | Polycomb complex protein BMI-1 (B lymphoma Mo- | Genecopoeia: NM_005180.8 |
| | MLV insertion region 1 homolog) | |
| SATB2 | Special AT-rich sequence-binding protein 2 | Genecopoeia: NM_015265.3 |
| SMARCC2 | SWI/SNF-related matrix-associated actin-dependent | Genecopoeia: BC013045.1 |
| | regulator of chromatin subfamily C member 2 | |
| RCOR1 | REST corepressor 1 | Genecopoeia: NM_015156.3 |

### (C) Protein Domain Information.

| Domain | | |
|---|---|---|
| name | Domain information | PFAM Accession # |
| LBD | Ligand-binding domain of nuclear | PF00104 |
| | hormone receptor | |
| Homeo | Homeobox domain | PF00046 |
| VHL | von Hippel-Lindau disease tumor | PF01847 |
| | suppressor | |
| EF1_GNE | EF-1 guanine nucleotide exchange | PF00736 |
| | domain | |
| UBC | Ubiquitin-conjugating enzyme | PF00179 |
| RBD | Raf-like Ras-binding domain | PF02196 |
| Pcc1 | Transcription factor Pcc1 | PF09341 |
| SH2 | Src Homology 2 domain | PF00017 |
| SH3 | SRC Homology 3 domain | PF00018 |
| CA | Cadherin domain | PF00028 |
| Ig | Immunoglobulin domain | PF00047 |
| Cap_Gly | CAP-Gly domain | PF01302 |
| Recep_L | Receptor L domain | PF01030 |
| Ubox | U-box domain | PF04564 |
| Nedd8 | Cullin protein neddylation domain | PF10557 |
| RING | Zinc finger, C3HC4 type | PF00097 |
| | (RING finger) | |
| SWIRM | SWIRM domain | PF04433 |
| SANT | SANT SWI3, ADA2, N-CoR and | SMART: SM00717 |
| | TFIIIB″ DNA-binding domains | |

The fourth group of experiments were carried out with the goal of identifying new components of large protein-protein complexes. Two previously uncharacterized interactions were validated between the special AT-rich sequence-binding protein SATB2 and the Emerin ‘proteome’ complex 32, and one involving the pre-mRNA-processing factor PRPF19 and the centromere chromatin complex (FIG. 16). In one embodiment, the detected PPIs can be confirmed through appropriate in vivo experiments. Taken together, these findings indicate that PrePPI has sufficient accuracy and sensitivity to provide a wealth of novel hypotheses that can drive biological discovery.

### Discussion

The methods and systems disclosed herein have proven to have a high level of accuracy and range of applicability. Most protein complexes in the PDB have structural neighbors that share binding properties²², and protein interface space can be close to ‘complete’ in terms of the packing orientations of secondary structure elements²³. Moreover, these elements can be identified with geometric alignment methods^{22,99}, a fact that has been exploited in presently disclosed subject matter.

### Example 3

### The PREPPI Database

A PPI prediction method (PrePPI) that is largely based on 3D protein structural is described herein. The PrePPI prediction model shows that the exploitation of homology models and remote geometric relationships, structural information can be used to accurately predict protein-protein interactions on a genome-wide scale. The further integration of structural with other functional clues yields prediction performance comparable to high-throughput experiments. Experimental tests of a number of predictions demonstrate the ability of the structure-based algorithm to identify novel, unsuspected PPIs of significant biological interest.

Given the inconsistent levels of reliability and lack of complete overlap between different PPI databases, the present systems and methods, which integrate different sources of information and report an appropriate measure of reliability is extremely valuable. The PrePPI database contains interactions predicted from the PrePPI prediction method, and also includes interactions compiled from a set of public databases that manually curate experimentally determined PPIs from the literature. A probability for each interaction is calculated using a Bayesian framework as described below.

### Data Sources

### Predicted Interactions

Predicted interactions in the PrePPI database are generated by the structure-based integrative PPI prediction method that combines structural modeling with other genomic, evolutionary and functional clues¹⁰⁰. Briefly, and as described herein, for a pair of proteins of interest, representative structures of the query proteins are searched for in the PDB and homology model databases and then use these to search for structural neighbors of each protein. A protein-protein complex found in the PQS or PDB database is used as a ‘template’ for the interaction whenever it contains a pair of interacting chains that are structural neighbors of the respective query proteins. A model is then constructed by superposing the individual subunits on their corresponding structural neighbors in the template complex, and an LR is calculated for each model to represent a true interaction using a Bayesian network trained on a positive and a negative interaction reference set. The structure-derived LR is combined with non-structural evidence associated with the query proteins using a naive Bayesian classifier.

The performance of the prediction method is comparable to high-throughput studies, and that this is due at least in part to the large scale use of structural information made possible by the use of homology models and looking broadly across protein structure space for structure/function relationships.

### Experimentally Determined Interactions

PPIs were collected from six publically available databases (MIPS, DIP, IntAct, MINT, HPRD, BioGRID) resulting in 117,803 interactions for yeast and 82,060 interactions for human. Protein identifiers were mapped from different databases to UniProt accession numbers and used pairs of accession numbers as the unique identifiers of all PPIs. Different databases contain different numbers of false positive and false negative interactions that are due to both experimental and curation errors. Bayesian statistics were used to calculate an LR for database interactions as follows. A positive reference set was used that contains 11,851 yeast interactions and 7,409 human interactions that have more than one supporting publication, and a negative reference set constructed by pairing proteins located in different cellular compartments¹⁰⁰. Each of these interactions was assigned to one of seven categories and calculated an LR for each category. The first category contains interactions that are present in multiple databases and the other six contain interactions present in exclusively one of the databases listed above. In this way an objective evaluation is obtained that accounts for both experimental and curation quality.

### Combining the LRs for Predicted and Experimentally Determined Interactions

An advantage of using a Bayesian framework to calculate an LR for each database is that experimentally determined interactions can be easily combined with computationally predicted interactions. Because the two are only weakly correlated, a naïve Bayesian classifier was used to combine them by simply multiplying the two LR scores to obtain a combined LR score for each interaction.

In the PrePPI database the combined LR was scaled to a probability using the following equation:

$$probability = \frac{LR}{LR + {LR}_{cutoff}} \qquad Equation ( 1 )$$

An LR_{cutoff}, of 600 was used, which roughly corresponds to a false positive rate of 0.001, based on the assumption that the probability that an interaction of LR 600 is true is 0.5^{100, 6}.

The PrePPI database contains about two million PPIs with a probability greater than 0.1. Of these, 61,720 PPIs for yeast and 372,545 PPIs for human that have a probability greater than higher than 0.5.

### Web Interface

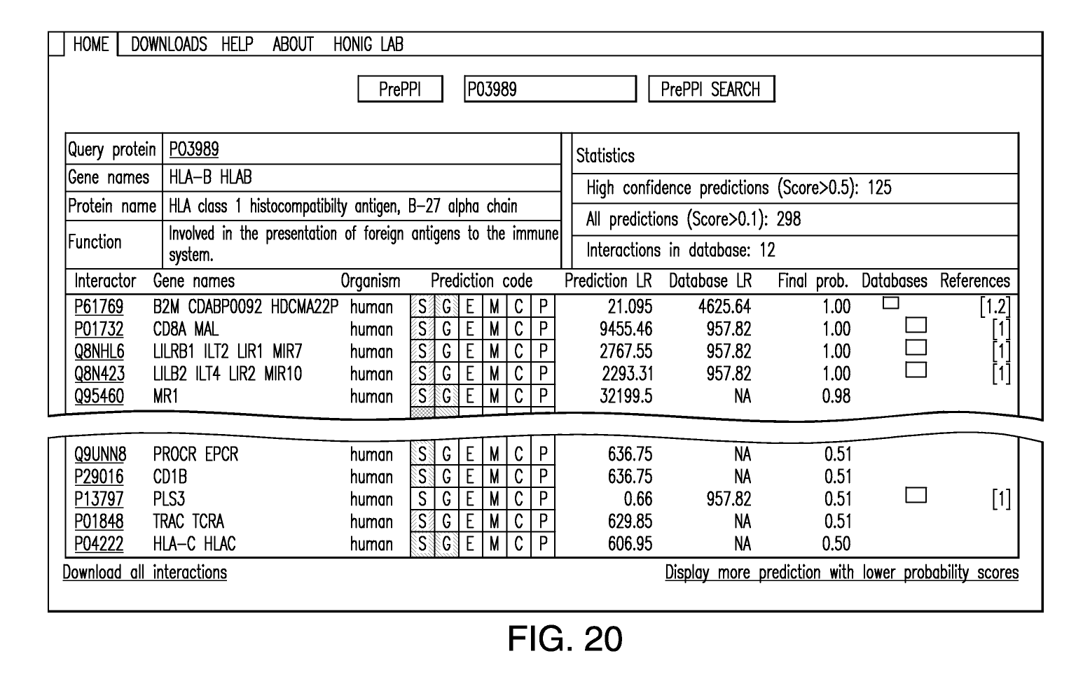

The PrePPI database can be queried though the UniProt accession number (e.g. P03989), gene name (e.g. PRNP), or protein name (e.g. Histone H2A) of a gene or protein. The server will return a description of the query protein, the number of proteins it interacts with, and a table with detailed information about each interaction (FIG. 20). Each row of the table lists proteins predicted to interact with the query, the sources of information used in the prediction, different LRs and the final combined probability, and whether the interaction has been documented in databases or in the literature.

The sources of information used in the prediction are represented by their “prediction codes.” Details on different types of information can be found in the “Help” page of the web server. The “Prediction LR” column shows the likelihood ratio (LR) obtained from the Bayesian network that combines the different sources of structural and non-structural evidence for the interaction represented by their prediction codes (see reference [100] for details on the types of evidence used). A “database LR” as described above was also calculated and combined this with the prediction LR to get a final LR, which is shown in the table as a probability (“Final prob.”) determined from Equation 1. If an interaction has been previously documented, the corresponding database symbols were put in the seventh column and the PubMed links to the description of the relevant experiments in the eighth column.

Interactions are ordered according to their final probabilities. By default, only the high confidence predictions (final probability>0.5) are shown, but predictions with lower probabilities can be viewed by clicking the link at the bottom right. All interactions for the query protein can be downloaded by clicking the link at the bottom left.

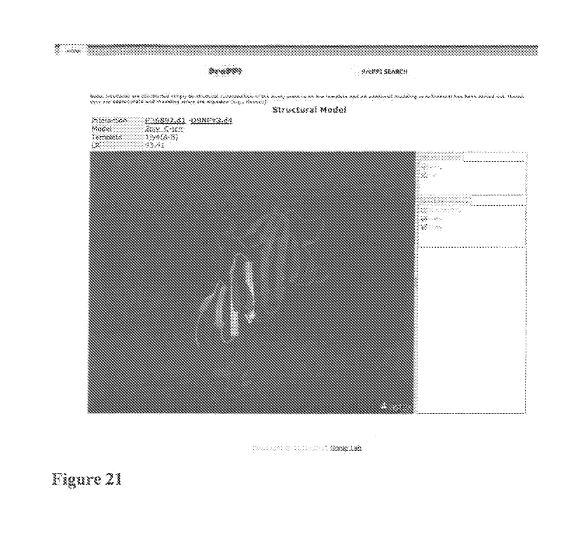

One feature of the PrePPI database is the availability of structural interaction models for those PPIs predicted from the structural modeling algorithm. FIG. 21 shows an example of an interaction model built for the human TGF-beta receptor type-1 (P36897) and the complement component C1q receptor (Q9NPY3), using a homology model from Skybase¹⁵ for Q9NPY3 and exploiting the remote structural relationship between these monomer structures and a designed protein that forms a homodimer¹⁰¹. Users can investigate the interaction model and generate experimentally testable hypotheses for how the two proteins interact. No structural refinement of PrePPI models is carried out so they can contain physically unrealistic features such as steric clashes. The structure-based LR and probability for the model are shown in the viewer and, together with the reasonableness of the model itself, should be considered when evaluating its biological relevance and when deciding whether some form of structural refinement can be of value.

### REFERENCES

1. Yu, H. et al. High-quality binary protein interaction map of the yeast interactome network. Science 322, 104-110 (2008).
2. Davis, F. P. and A. Sali, PIBASE: a comprehensive database of structurally defined protein interfaces. Bioinformatics, 2005. 21(9): p. 1901-7.
3. Zhang, Q. C., et al., PredUs: a web server for predicting protein interfaces using structural neighbors. Nucleic Acids Res, 2011.
4. Liang, S., et al., Protein binding site prediction using an empirical scoring function. Nucleic Acids Res, 2006. 34(13): p. 3698-707.
5. Chen, H. L. and H. X. Zhou, Prediction of interface residues in protein-protein complexes by a consensus neural network method: Test against NMR data. Proteins-Structure Function and Bioinformatics, 2005. 61(1): p. 21-35.
6. Jansen, R., et al., A Bayesian networks approach for predicting protein-protein interactions from genomic data. Science, 2003. 302(5644): p. 449-53.
7. Ruepp, A., et al., CORUM: the comprehensive resource of mammalian protein complexes—2009. Nucleic Acids Res, 2010. 38(Database issue): p. D497-501.
8. Berman, H. M. et al. The Protein DataBank. Nucleic Acids Res. 28, 235-242 (2000).
9. Pieper, U. et al. MODBASE: a database of annotated comparative protein structure models and associated resources. Nucleic Acids Res. 34, D291-D295 (2006).
10. Arnold K., Bordoli L., Kopp J., and Schwede T. (2006). The SWISS-MODEL Workspace: A web-based environment for protein structure homology modelling. Bioinformatics, 22, 195-201
11. E. Meyers and W. Miller, Comput. Appl. Biosci., 4:11-17 (1988)
12. Needleman and Wunsch, J. Mol. Biol. 48:444-453 (1970)
13. Altschul, et al. J. Mol. Biol. 215:403-10, (1990)
14. Altschul et al., Nucleic Acids Res. 25(17):3389-3402 (1997)
15. Mirkovic, N., Li, Z., Parnassa, A. & Murray, D. Strategies for high-throughput comparative modeling: applications to leverage analysis in structural genomics and protein family organization. Proteins 66, 766-777 (2007).
16. Yang, A. S. & Honig, B. An integrated approach to the analysis and modeling of protein sequences and structures. I. Protein structural alignment and a quantitative measure for protein structural distance. J. Mol. Biol. 301, 665-678 (2000).
17. Petrey, D.& Honig, B. GRASP2: visualization, surface properties, and electrostatics of macromolecular structures and sequences. Methods Enzymol. 374, 492-509 (2003).
18. Holm, L. and Sander, C. (1995) Dali: a network tool for protein structure comparison. Trends in Biochemical Sciences, 20, 478-480
19. Ortiz, A. R., Strauss, C. E. M. and Olmea, O. (2002) MAMMOTH (Matching molecular models obtained from theory): An automated method for model comparison. Protein Science, 11, 2606-2621
20. Orengo, C. A. and Taylor, W. R. (1996) SSAP: Sequential structure alignment program for protein structure comparison. In Russell, F. D. (ed.), Methods Enzymol. Academic Press, Vol. Volume 266, pp. 617-635
21. Tunebag, N., Gursoy, A., Guney, E., Nussinov, R. & Keskin, O. Architectures and functional coverage of protein-protein interfaces. J. Mol. Biol. 381, 785-802 (2008).
22. Zhang, Q. C., Petrey, D., Norel, R. & Honig, B. H. Protein interface conservation across structure space. Proc. Natl. Acad. Sci. USA 107, 10896-10901 (2010).
23. Gao, M. & Skolnick, J. Structural space of protein-protein interfaces is degenerate, close to complete, and highly connected. Proc. Natl. Acad. Sci. USA 107, 22517-22522 (2010).
24. Lefebvre, C. et al. A human B-cell interactome identifies MYB and FOXM1 as master regulators of proliferation in germinal centers. Mol. Syst. Biol. 6, 377 (2010).
25. Jansen, R. et al. A Bayesian networks approach for predicting protein-protein interactions from genomic data. Science 302, 449-453 (2003).
26. von Mering, C. et al. STRING: known and predicted protein-protein associations, integrated and transferred across organisms. Nucleic Acids Res. 33, D433-D437 (2005).
27. Li, S., Armstrong, C. M., Bertin, N., Ge, H., Milstein, S., Boxem, M., Vidalain, P. O., Han, J. D., Chesneau, A., Hao, T. et al. (2004) A map of the interactome network of the metazoan C. elegans. Science, 303, 540-543.
28. Butland, G., Peregrin-Alvarez, J. M., Li, J., Yang, W., Yang, X., Canadien, V., Starostine, A., Richards, D., Beattie, B., Krogan, N. et al. (2005) Interaction network containing conserved and essential protein complexes in Escherichia coli. Nature, 433, 531-537.
29. Kuhner, S., van Noort, V., Betts, M. J., Leo-Macias, A., Batisse, C., Rode, M., Yamada, T., Maier, T., Bader, S., Beltran-Alvarez, P. et al. (2009) Proteome organization in a genome-reduced bacterium. Science, 326, 1235-1240.
30. Rual, J. F., Venkatesan, K., Hao, T., Hirozane-Kishikawa, T., Dricot, A., Li, N., Berriz, G. F., Gibbons, F. D., Dreze, M., Ayivi-Guedehoussou, N. et al. (2005) Towards a proteome-scale map of the human protein-protein interaction network. Nature, 437, 1173-1178.
31. Aloy, P. & Russell, R. B. Interrogating protein interaction networks through structural biology. Proc. Natl Acad. Sci. USA 99, 5896-5901 (2002).
32. Lu, L., Lu, H. & Skolnick, J. MULTIPROSPECTOR: an algorithm for the prediction of protein-protein interactions by multimeric threading. Proteins 49, 350-364 (2002).
33. Davis, F. P. et al. Protein complex compositions predicted by structural similarity. Nucleic Acids Res. 34, 2943-2952 (2006).
34. Apweiler, R. et al. UniProt: the Universal Protein knowledgebase. Nucleic Acids Res. 32, D115-D119 (2004).
35. Letunic, I., Doerks, T. & Bork, P. SMART 6: recent updates and new developments. Nucleic Acids Res. 37, D229-D232 (2009).
36. Berman, H. M. et al. The Protein DataBank. Nucleic Acids Res. 28, 235-242 (2000).
37. Altschul, S. F. et al. Gapped BLAST and PSI-BLAST: a new generation of protein database search programs. Nucleic Acids Res. 25, 3389-3402 (1997).
38. Chen, H. L. and H. X. Zhou, Prediction of interface residues in protein-protein complexes by a consensus neural network method: Test against NMR data. Proteins-Structure Function and Bioinformatics, 2005. 61(1): p. 21-35.
39. Yang, A. S. & Honig, B. An integrated approach to the analysis and modeling of protein sequences and structures. I. Protein structural alignment and a quantitative measure for protein structural distance. J. Mol. Biol. 301, 665-678 (2000).
40. Henrick, K.&Thornton, J. M. PQS: a protein quaternary structure file server. Trends Biochem. Sci. 23, 358-361 (1998).
41. Krissinel, E.&Henrick, K. Inference of macromolecular assemblies from crystalline state. J. Mol. Biol. 372, 774-797 (2007).
42. Jansen, R., et al., A Bayesian networks approach for predicting protein-protein interactions from genomic data. Science, 2003. 302(5644): p. 449-53.
43. Myers, C. L., et al., Finding function: evaluation methods for functional genomic data. BMC Genomics, 2006. 7: p. 187.
44. von Mering, C., et al., Comparative assessment of large-scale data sets of protein-protein interactions. Nature, 2002. 417(6887): p. 399-403.
45. Lefebvre, C., et al., A human B-cell interactome identifies MYB and FOXM1 as master regulators of proliferation in germinal centers. Molecular Systems Biology, 2010. 6: p. 377.
46. Yu, H., et al., High-quality binary protein interaction map of the yeast interactome network. Science, 2008. 322(5898): p. 104-10.
47. Mewes, H. W., et al., MIPS: a database for protein sequences, homology data and yeast genome information. Nucleic Acids Research, 1997. 25(1): p. 28-30.
48. Salwinski, L., et al., The Database of Interacting Proteins: 2004 update. Nucleic Acids Research, 2004. 32 (Database issue): p. D449-51.
49. Stark, C., et al., BioGRID: a general repository for interaction datasets. Nucleic Acids Research, 2006. 34: p. D535-D539.
50. Kerrien, S., et al., IntAct—open source resource for molecular interaction data. Nucleic Acids Res, 2007. 35(Database issue): p. D561-5.
51. Chatraryamontri, A., et al., MINT: the Molecular INTeraction database. Nucleic Acids Res, 2007. 35(Database issue): p. D572-4.
52. Keshava Prasad, T. S., et al., Human Protein Reference Database—2009 update. Nucleic Acids Res, 2009. 37(Database issue): p. D767-72.
53. The Gene Ontology Consortium. Gene Ontology: tool for the unfication of biology. Nature Geneet. 25, 25-29 (2000).
54. Gavin, A. C., et al., Proteome survey reveals modularity of the yeast cell machinery. Nature, 2006. 440(7084): p. 631-6.
55. Keshava Prasad, T. S., Goel, R., Kandasamy, K., Keerthikumar, S., Kumar, S., Mathivanan, S., Telikicherla, D., Raju, R., Shafreen, B., Venugopal, A. et al. (2009) Human Protein Reference Database—2009 update. Nucleic Acids Res, 37, D767-772.
56. Tarassov, K., et al., An in vivo map of the yeast protein interactome. Science, 2008. 320(5882): p. 1465-70.
57. Rual, J. F., et al., Towards a proteome-scale map of the human protein-protein interaction network. Nature, 2005. 437(7062): p. 1173-8.
58. Stelzl, U., et al., A human protein-protein interaction network: a resource for annotating the proteome. Cell, 2005. 122(6): p. 957-68.
59. Yu, H., Braun, P., Yildirim, M. A., Lemmens, I., Venkatesan, K., Sahalie, J., Hirozane-Kishikawa, T., Gebreab, F., Li, N., Simonis, N. et al. (2008) High-quality binary protein interaction map of the yeast interactome network. Science, 322, 104-110.
60. Wass, M. N., Fuentes, G., Pons, C., Pazos, F. & Valencia, A. Towards the prediction of protein interaction partners using physical docking. Mol. Syst. Biol. 7, 469 (2011).
61. Ewing, R. M. et al. Large-scale mapping of human protein-protein interactions by mass spectrometry. Mol. Syst. Biol. 3, 89 (2007).
62. Chen, H. L. & Zhou, H. X. Prediction of interface residues in protein-protein complexes by a consensus neural network method: test against NMR data. Proteins 61, 21-35 (2005).
63. Liang, S., Zhang, C., Liu, S. & Zhou, Y. Protein binding site prediction using an empirical scoring function. Nucleic Acids Res. 34, 3698-3707 (2006).
64. Zhang, Q. C. et al. PredUs: a web server for predicting protein interfaces using structural neighbors. Nucleic Acids Res. 39, 283-287 (2011).
65. Yu, H. et al. High-quality binary protein interaction map of the yeast interactome network. Science 322, 104-110 (2008).
66. Lefebvre, C., et al., A human B-cell interactome identifies MYB and FOXM1 as master regulators of proliferation in germinal centers. Molecular Systems Biology, 2010. 6: p. 377.
67. Stolovitzky, G., Prill, R. J. & Califano, A. Lessons from the DREAM2 challenges. Ann. NY Acad. Sci. 1158, 159-195 (2009).
68. Stolovitzky, G., Prill, R. J. & Califano, A. Lessons from the DREAM2 challenges. Ann. NY Acad. Sci. 1158, 159-195 (2009).
69. Yu, H. et al. High-quality binary protein interaction map of the yeast interactome network. Science 322, 104-110 (2008).
70. Uetz, P., et al., A comprehensive analysis of protein-protein interactions in Saccharomyces cerevisiae. Nature, 2000. 403(6770): p. 623-7.
71. Ito, T., et al., A comprehensive two-hybrid analysis to explore the yeast protein interactome. Proc Natl Acad Sci USA, 2001. 98(8): p. 4569-74.
72. Yu, H., et al., High-quality binary protein interaction map of the yeast interactome network. Science, 2008. 322(5898): p. 104-10.
73. Ho, Y., et al., Systematic identification of protein complexes in Saccharomyces cerevisiae by mass spectrometry. Nature, 2002. 415(6868): p. 180-3.
74. Gavin, A. C., et al., Functional organization of the yeast proteome by systematic analysis of protein complexes. Nature, 2002. 415(6868): p. 141-7.
75. Krogan, N. J., et al., Global landscape of protein complexes in the yeast Saccharomyces cerevisiae. Nature, 2006. 440(7084): p. 637-43.
76. Gavin, A. C., et al., Proteome survey reveals modularity of the yeast cell machinery. Nature, 2006. 440(7084): p. 631-6.
77. Tarassov, K., et al., An in vivo map of the yeast protein interactome. Science, 2008. 320(5882): p. 1465-70.
78. Rual, J. F., et al., Towards a proteome-scale map of the human protein-protein interaction network. Nature, 2005. 437(7062): p. 1173-8.
79. Stelzl, U., et al., A human protein-protein interaction network: a resource for annotating the proteome. Cell, 2005. 122(6): p. 957-68.
80. Ewing, R. M., et al., Large-scale mapping of human protein-protein interactions by mass spectrometry. Mol Syst Biol, 2007. 3: p. 89.
81. Kerrien, S., Alam-Faruque, Y., Aranda, B., Bancarz, I., Bridge, A., Derow, C., Dimmer, E., Feuermann, M., Friedrichsen, A., Huntley, R. et al. (2007) IntAct—open source resource for molecular interaction data. Nucleic Acids Res, 35, D561-565.
82. Chatr-aryamontri, A., Ceol, A., Palazzi, L. M., Nardelli, G., Schneider, M. V., Castagnoli, L. and Cesareni, G. (2007) MINT: the Molecular INTeraction database. Nucleic Acids Res, 35, D572-574.
83. Apweiler, R. et al. UniProt: the Universal Protein knowledgebase. Nucleic Acids Res. 32, D115-D 119 (2004).
84. Levitt, M. Nature of the protein universe. Proc. Natl. Acad. Sci. USA 106, 1079-11084 (2009).
85. Chen, H. L. and H. X. Zhou, Prediction of interface residues in protein-protein complexes by a consensus neural network method: Test against NMR data. Proteins-Structure Function and Bioinformatics, 2005. 61(1): p. 21-35.
86. Liang, S., Zhang, C., Liu, S. & Zhou, Y. Protein binding site prediction using an empirical scoring function. Nucleic Acids Res. 34, 3698-3707 (2006).
87. Tontonoz, P. and B. M. Spiegelman, Fat and beyond: the diverse biology of PPARgamma. Annu Rev Biochem, 2008. 77: p. 289-312.
88. Yoshimura, A., T. Naka, and M. Kubo, SOCS proteins, cytokine signalling and immune regulation. Nat Rev Immunol, 2007. 7(6): p. 454-65.
89. Babon, J. J., et al., Suppression of cytokine signaling by SOCS3: characterization of the mode of inhibition and the basis of its specificity. Immunity, 2012. 36(2): p. 239-50.
90. Weiner, J. A., et al., Gamma protocadherins are required for synaptic development in the spinal cord. Proc Nail Acad Sci USA, 2005. 102(1): p. 8-14.
91. Kohmura, N., et al., Diversity revealed by a novel family of cadherins expressed in neurons at a synaptic complex. Neuron, 1998. 20(6): p. 1137-51.
92. Wu, Q. and T. Maniatis, A striking organization of a large family of human neural cadherin-like cell adhesion genes. Cell, 1999. 97(6): p. 779-90.
93. Schalm, S. S., et al., Phosphorylation of protocadherin proteins by the receptor tyrosine kinase Ret. Proc Natl Acad Sci USA, 2010. 107(31): p. 13894-9.
94. Plattner, R., et al., c-Abl is activated by growth factors and Src family kinases and has a role in the cellular response to PDGF. Genes Dev, 1999. 13(18): p. 2400-11.
95. Qiu, Z., Y. Cang, and S. P. Goff, Abl family tyrosine kinases are essential for basement membrane integrity and cortical lamination in the cerebellum. J Neurosci, 2010. 30(43): p. 14430-9.
96. Ko, H. S., et al., Phosphorylation by the c-Abl protein tyrosine kinase inhibits parkin's ubiquitination and protective function. Proc Natl Acad Sci USA, 2010. 107(38): p. 16691-6.
97. Bellon, A., et al., VEGFR2 (KDR/Flk1) signaling mediates axon growth in response to semaphorin 3E in the developing brain. Neuron, 2010. 66(2): p. 205-19.
98. Paganoni, S., J. Bernstein, and A. Ferreira, Ror1-Ror2 complexes modulate synapse formation in hippocampal neurons. Neuroscience, 2010. 165(4): p. 1261-74.
99. Keskin, O., Nussinov, R.& Gursoy, A. PRISM: protein-protein interaction prediction by structural matching. Methods Mol. Biol. 484, 505-521 (2008).
100. Zhang, Q. C., Petrey, D., Deng, L., Qiang, L., Shi, Y., Thu, C.A., Bisikirska, B., Lefebvre, C., Accili, D., Hunter, T. et al. (2012) Structure-based prediction of protein-protein interactions on a genome-wide scale. NATURE, 490, 556-560.
101. Venkatraman, J., Nagana Gowda, G. A. and Balaram, P. (2002) Design and Construction of an Open Multistranded β-Sheet Polypeptide Stabilized by a Disulfide Bridge. Journal of the American Chemical Society, 124, 4987-4994.

Various publications, patents and patent applications are cited herein, the contents of which are hereby incorporated by reference in their entireties.

1. A method for identifying a molecular interaction between at least two query molecules, comprising:
a. generating, using a processing arrangement, at least two structural representatives corresponding to the at least two query molecules;
b. modeling an interaction between the at least two query molecules to generate a modeled interaction;
c. generating one or more structural-based scores to assess the modeled interaction;
d. combining the one or more structural-based scores into a combined structural-based score;
e. generating one or more non-structural based scores to assess the modeled interaction; and
f. determining a likelihood that the modeled interaction represents a true interaction from the combined structural-based score and the one or more non-structural based scores.

2. The method of claim 1, wherein the at least two query molecules are selected from the group consisting of amino acid polymers, nucleic acids and small molecules.

3. The method of claim 1, wherein the modeling comprises using a template complex.

4. The method of claim 3, wherein the template complex comprises at least two structural neighbors corresponding to the at least two query molecules.

5. The method of claim 1, wherein the generated one or more structural-based scores correspond to one or more scores determined by one or more of the following:
a. determining a geometric similarity between the modeled interaction and the template complex;
b. determining a number of interacting residue pairs in the template complex that are preserved in the modeled interaction;
c. determining a fraction of interacting residue pairs in the template complex that are preserved in the modeled interaction;
d. determining a number of interacting residue pairs in the template complex that align to a predicted interfacial residue in the modeled interaction; and
e. determining a number of interfacial residues in the template complex that align with predicted interfacial residues in the modeled interaction.

6. The method of claim 1, wherein the generated one or more non-structural based scores comprises using one or more of: gene ontology functional similarity, MIPS functional similarity, phylogenetic profile similarity, gene co-expression.

7. The method of claim 1, wherein the combining the one or more structural-based scores comprises using a Bayesian network.

8. The method of claim 7, wherein the Bayesian network comprises a network trained on a positive and a negative interaction reference set.

9. The method of claim 8, wherein the positive interaction reference set comprises a set divided into high-confidence and low-confidence subsets.

10. The method of claim 8, wherein the negative interaction reference set comprises interactions that are not included in the high-confidence and low-confidence subsets.

11. The method of claim 1, wherein the determining a likelihood that the modeled interaction represents a true interaction further comprises using a Naïve Bayesian classifier.

12. A method for identifying a protein-protein interaction between at least two query proteins, comprising:
a. generating, using a processing arrangement, at least two structural representatives corresponding to the at least two query proteins;
b. modeling an interaction between the at least two query proteins to generate a modeled interaction;
c. generating one or more structural-based scores to assess the modeled interaction;
d. combining the one or more structural-based scores into a combined structural-based score;
e. generating one or more non-structural based scores to assess the modeled interaction; and
f. determining a likelihood that the modeled interaction represents a true interaction from the combined structural-based score and the one or more non-structural based scores.

13. The method of claim 12, wherein the generating at least two structural representatives comprises identifying structures that have about 90% or more sequence homology to the at least two query proteins.

14. A system for identifying a molecular interaction between at least two query molecules, the system comprising a non-transitory computer-readable medium having instructions stored thereon that, when executed, cause a processor to:
a. generate at least two structural representatives corresponding to the at least two query molecules;
b. model an interaction between the at least two query molecules to generate a modeled interaction;
c. generate one or more structural-based scores to assess the modeled interaction;
d. combine the one or more structural-based scores into a combined structural-based score;
e. generate one or more non-structural based scores to assess the modeled interaction; and
f. determine a likelihood that the modeled interaction represents a true interaction from the combined structural-based score and the one or more non-structural based scores.

15. The system of claim 14, further comprising one or more processors coupled to the computer-readable medium.

16. The system of claim 14, further comprising a transceiver for receiving the at least two query molecules.

17. The system of claim 14, wherein the combining the one or more structural-based score comprises using a Bayesian network.

18. The system of claim 14, wherein the determining a likelihood that the modeled interaction represents a true interaction further comprises using a Naive Bayesian classifier.
